(19) United States
(12) Patent Application Publication
(10) Pub. No.: US 2015/0008767 A1
(43) Pub. Date: Jan. 8, 2015

(54) INSULATED TRANSMISSION MEDIUM AND INSULATED TRANSMISSION APPARATUS

(71) Applicants: Hiroshi Shinoda, Tokyo (JP); Takahide Terada, Tokyo (JP); Kazunori Hara, Tokyo (JP)

(72) Inventors: Hiroshi Shinoda, Tokyo (JP); Takahide Terada, Tokyo (JP); Kazunori Hara, Tokyo (JP)

(21) Appl. No.: 14/381,674

(22) PCT Filed: Mar. 30, 2012
(86) PCT No.: PCT/JP2012/002219

§ 371 Date: Sep. 8, 2014

(51) Int. Cl. H02J 5/00; H02N 2/18

(52) U.S. Cl. CPC H02J 5/00; H02N 2/18
USPC 307/149

(57) ABSTRACT

Provided is an insulated transmission medium which transmits electromagnetic energy between circuits having different reference potentials and has high insulation reliability. In order to realize the insulated transmission medium with a low loss, a small size, and a low cost, the insulated transmission medium according to the present invention is an insulated transmission medium which transmits the electromagnetic energy between a first circuit having a first reference potential and a second circuit having a second reference potential. The insulated transmission medium includes a first resonator and a second resonator connected to the first circuit and the second circuit, respectively, the first resonator and the second resonator are respectively configured as a first conductor group and a second conductor group using conductors in a dielectric material multilayer substrate including a plurality of dielectric material layers, and the first conductor group and the second conductor group are coated with the dielectric material and are isolated from each other.

### TECHNICAL FIELD

The present invention relates to an insulated transmission medium and an insulated transmission apparatus that transmit electromagnetic energy between a first circuit and a second circuit having different reference potentials while maintaining insulating properties.

### BACKGROUND ART

For example, PTL 1 discloses a power conversion apparatus including a switching element to control a current flowing to a load, a control circuit to generate a control signal for the switching element, a driving circuit to drive a control terminal of the switching element on the basis of the control signal, and insulating transformers configured to make a primary winding and a secondary winding arranged to face each other by semiconductor process technology to insulate the control circuit and the driving circuit from each other and to be separated from each other by a glass substrate or a ceramic substrate, as an insulated communication system. For example, PTL 1 discloses a configuration in which the primary winding and the secondary winding are formed as coil patterns on a semiconductor substrate, a distance between the windings is about several-ten μm, the control signal is transmitted by electromagnetic induction, and insulated communication with a small size and a high insulating property is enabled.

PTL 2 discloses a band pass filter in which a filter structure for a ultra wide band (UWB) is realized, conductor patterns and dielectric material layers are alternately laminated, N (N≧2) resonators are arranged to partially overlap each other in a lamination direction, and one end of each resonator is connected to a ground. PTL 2 discloses a configuration in which, even though a distance between the resonators is more than 500 μm, strong coupling is obtained by surface coupling in an overlapping portion and a low-loss passage characteristic and an out-of-band steep attenuation characteristic are obtained in a wide band.

### CITATION LIST

### Patent Literature

PTL 1: JP 2008-270490 A

PTL 2: JP 2007-097113 A

### SUMMARY OF INVENTION

### Technical Problem

According to the technology using the insulating transformers described in PTL 1, manufacturing using the semiconductor process technology is assumed and a thickness of an insulating film manufactured between the primary winding and the secondary winding is small as about several-ten μm. The thickness is enough for dielectric breakdown resistance (dielectric breakdown voltage) at the time of a shipment. However, in an apparatus such as a railroad vehicle of which the operative number of years is more than ten years, an insulator thickness more than several-hundred μm not controlled by the semiconductor process technology is necessary in consideration of insulation deterioration by an overvoltage application or a continuous operation. In addition, because the primary winding and the secondary winding are configured as the coil patterns, there is concern in noise resistance of a low frequency region. For example, it is thought that switching noise of an inverter is easily picked up and an operation becomes unstable. When it is considered that the same technology is applied to feeding, an increase in the distance between the primary winding and the secondary winding leads to an increase in transmission loss and power supply of high efficiency is difficult.

According to the technology using the band pass filter described in PTL 2, even though the distance between the resonators is set to 500 μm or more, low-loss transmission is enabled. However, one end of each resonator is connected to a ground and each resonator is physically connected through a ground conductor. Therefore, the resonators are not insulated from each other and the technology cannot be used for insulated communication, and insulated feeding.

Recently, in an electronic apparatus, the number of wiring lines between modules and components configuring the apparatus increases, which results in disturbing a small size, a low cost, and reliability improvement of the apparatus. As one mechanism for decreasing the number of wiring lines, a general wireless communication system such as a wireless local area network (LAN) is introduced. However, an electromagnetic wave is irregularly reflected on a metal wall surface of a casing to cause communication quality to become unstable.

In addition, as for a conventional removable connector for connection, there are problems in terms of reliability and cost and needs to connection between components in which physical removal is unnecessary and electrodes are not exposed increase. As an insulated communication system for an inverter used for motors of an electric vehicle, a railroad vehicle, and the like, a set of an optical module and an optical fiber in which insulation can be secured relatively easily and actual performance is proven is used in the present circumstances. However, as for a method using the optical fiber, there are problems in terms of a cost, reliability such as a life and an erroneous operation of a compound semiconductor configuring a photodiode, and damage or erroneous connection at the time of outfitting (assembling) and an alternative mechanism is required.

In addition, as a so-called insulated feeding system for power supply to a gate driver, a transformer component of a substrate mounting type is used in the present circumstances. Because the transformer component has a large size, a large weight, and a high cost, the transformer component becomes an obstacle to a small size, a small weight, and a low cost of the gate driver and an alternative mechanism is required, similar to the above case.

### Solution to Problem

A representative example of the invention is as follows. An insulated transmission medium of the present invention includes: a dielectric material multilayer substrate which includes a plurality of dielectric material layers; a first resonator which is provided on the substrate and has a first reference potential; and a second resonator which is provided on the substrate, has a second reference potential different from the first reference potential, and is electrically insulated from the first resonator, wherein electromagnetic energy is transmitted between the first resonator and the second resonator.

In addition, an insulated transmission apparatus according to the invention includes an insulated transmission medium having a dielectric material multilayer substrate which includes a plurality of dielectric material layers, a first resonator which is provided on the substrate and has a first reference potential, and a second resonator which is provided on the substrate, has a second reference potential different from the first reference potential, and is electrically insulated from the first resonator, the first resonator including a first main resonating unit and a first auxiliary resonating unit; a first circuit which is electrically connected to the first resonator of the insulated transmission medium; and a second circuit which is electrically connected to the second resonator of the insulated transmission medium. The electromagnetic energy is transmitted between the first circuit and the second circuit through the insulated transmission medium.

### Advantageous Effects of Invention

According to the invention, an insulated transmission medium and an insulated transmission apparatus capable of maintaining insulation reliability over a long period and suitable for an insulated communication system and an insulated feeding system with a low loss, a small size, and a low cost can be provided.

Other objects, configurations, and effects will become apparent from the following detailed description based on embodiments.

### BRIEF DESCRIPTION OF DRAWINGS

FIG. 1 is a perspective view illustrating a configuration of an insulated transmission medium 200 according to a first embodiment and viewed from a longitudinal cross-section and a circuit block diagram using the insulated transmission medium 200.

FIG. 2(a) is a horizontal cross-sectional view taken along a surface A1-A1′ of a dielectric material multilayer substrate 101 of FIG. 1, FIG. 2 (b) is a horizontal cross-sectional view taken along a surface A2-A2′, and FIG. 2 (c) is a horizontal cross-sectional view taken along a surface A3-A3′.

FIG. 3 is an equivalent circuit diagram of the insulated transmission medium 200 according to the first embodiment.

FIG. 4 illustrates an actual measurement result of the insulated transmission medium according to the first embodiment.

FIG. 5 (a) is a diagram illustrating design parameters in a perspective view viewed from a longitudinal cross-section of the insulated transmission medium 200 according to the first embodiment and FIG. 5 (b) is a diagram illustrating design parameters in the horizontal cross-sectional view taken along the surface A2-A2′ of the dielectric material multilayer substrate 101.

FIG. 6A is a diagram illustrating a modification example of a resonator of the insulated transmission medium 200 according to the first embodiment.

FIG. 6B is a diagram illustrating a modification example of the resonator of the insulated transmission medium 200 according to the first embodiment.

FIG. 6C is a diagram illustrating a modification example of the resonator of the insulated transmission medium 200 according to the first embodiment.

FIG. 6D is a diagram illustrating a modification example of the resonator of the insulated transmission medium 200 according to the first embodiment.

FIG. 6E is a diagram illustrating a modification example of the resonator of the insulated transmission medium 200 according to the first embodiment.

FIG. 6F is a diagram illustrating a modification example of the resonator of the insulated transmission medium 200 according to the first embodiment.

FIG. 6G is a diagram illustrating a modification example of the resonator of the insulated transmission medium 200 according to the first embodiment.

FIG. 7 is a diagram illustrating the insulated transmission medium 200 in which the resonators according to the first embodiment are arranged in parallel.

FIG. 8 is a perspective view illustrating a configuration of an insulated transmission medium 200 according to a second embodiment and viewed from a longitudinal cross-section.

FIG. 9(a) is a horizontal cross-sectional view taken along a surface A1-A1′ of a dielectric material multilayer substrate 101 of FIG. 8, FIG. 9(b) is a longitudinal cross-sectional view taken along a surface B1-B1′, and FIG. 9(c) is a longitudinal cross-sectional view taken along a surface B2-B2′.

FIG. 10(a) is a horizontal cross-sectional view taken along the surface A1-A1′ of the dielectric material multilayer substrate 101 of FIG. 8, FIG. 10(b) is a longitudinal cross-sectional view taken along the surface B1-B1′, and FIG. 10(c) is a longitudinal cross-sectional view taken along the surface B2-B2′, which illustrate a modification example of the insulated transmission medium 200 according to the second embodiment.

FIG. 11 is a perspective view illustrating a configuration of an insulated transmission medium 200 according to a third embodiment and viewed from a longitudinal cross-section.

FIG. 12(a) is a horizontal cross-sectional view taken along a surface A2-A2′ of a dielectric material multilayer substrate 101 of FIG. 11 and FIG. 12 (b) is a horizontal cross-sectional view taken along a surface A3-A3′.

FIG. 13 (a) is a perspective view illustrating a modification example of the insulated transmission medium 200 according to the third embodiment and viewed from the longitudinal cross-section and FIG. 13 (b) is a horizontal cross-sectional view taken along a surface C1-C1′ of the dielectric material multilayer substrate 101.

FIG. 14 (a) is a perspective view illustrating a configuration of an insulated transmission medium 200 according to a fourth embodiment and viewed from a longitudinal cross-section and FIG. 14(b) is a perspective view illustrating a modification example thereof and viewed from a longitudinal cross-section.

FIG. 15(a) is a diagram illustrating the side of one resonator, with respect to the insulated transmission medium 200 according to the fourth embodiment to couple one resonator and two resonators, and FIG. 15 (b) is a diagram illustrating the side of the two resonators.

FIG. 16A is a diagram illustrating the side of one resonator, with respect to the insulated transmission medium 200 according to the fourth embodiment to couple one resonator and four resonators.

FIG. 16B is a diagram illustrating the side of the four resonators, with respect to the insulated transmission medium 200 according to the fourth embodiment to couple one resonator and the four resonators.

FIGS. 17 (a) and 17 (b) are diagrams illustrating a conductor layer of a first layer and a conductor layer of a second layer, respectively, with respect to an insulated transmission medium according to a fifth embodiment.

FIGS. 18(a) and 18(b) are longitudinal cross-sectional views taken along a surface 214a-214b and a surface 214c-214d of FIGS. 17(a) and 17 (b), respectively, with respect to the insulated transmission medium according to the fifth embodiment.

FIG. 19 is a diagram illustrating a bridge wiring line position according to the fifth embodiment.

FIG. 20 is a diagram represented by only contours of inner circumference and outer circumference of a winding conductor pattern wound at least once.

FIG. 21 is a diagram illustrating an outline of the winding conductor pattern wound at least once, shapes of opening surfaces of the conductor layers of the first and second layers, and the bridge wiring line position.

FIG. 22 is a diagram illustrating a modification of the winding conductor pattern of FIG. 21.

FIG. 23 is a diagram illustrating a modification of the winding conductor pattern of FIG. 22.

FIGS. 24 (a) and 24 (b) are diagrams illustrating the conductor layer of the first layer and the conductor later of the second layer, respectively, with respect to the insulated transmission medium according to the fifth embodiment.

FIGS. 25 (a) and 25 (b) are diagrams illustrating the insulated transmission medium according to the fifth embodiment and longitudinal cross-sectional views taken along a surface 236a-236b and a surface 236c-236d of FIGS. 25(a) and 25(b), respectively.

FIG. 26A is a diagram illustrating an outline of each conductor layer, with respect to an insulated transmission medium according to a sixth embodiment configured by four conductor layers and five dielectric material layers.

FIG. 26B is a diagram illustrating an outline of each conductor layer, with respect to the insulated transmission medium according to the sixth embodiment configured by the four conductor layers and the five dielectric material layers.

FIG. 26C is a diagram illustrating an outline of each conductor layer, with respect to the insulated transmission medium according to the sixth embodiment configured by the four conductor layers and the five dielectric material layers.

FIG. 26D is a diagram illustrating an outline of each conductor layer, with respect to the insulated transmission medium according to the sixth embodiment configured by the four conductor layers and the five dielectric material layers.

FIGS. 27(a) and 27(b) are longitudinal cross-sectional views taken along a surface 236a-236b and a surface 236c-236d of FIGS. 26A to 26D, respectively, with respect to the insulated transmission medium according to the sixth embodiment configured by the four conductor layers and the five dielectric material layers.

FIG. 28 illustrates a configuration example of an insulated transmission apparatus according to a seventh embodiment of the present invention.

FIGS. 29 (a) and 29 (b) illustrate a configuration example of the insulated transmission apparatus according to the seventh embodiment of the present invention.

FIG. 30 illustrates an example of an application of the insulated transmission apparatus according to the seventh embodiment of the present invention to an inverter.

FIGS. 31 (a) to 31(c) illustrate a configuration example of an insulated transmission apparatus according to an eighth embodiment of the present invention.

FIGS. 32 (a) and 32 (b) illustrate a configuration example of the insulated transmission apparatus according to the eighth embodiment of the present invention.

FIGS. 33(a) to 33(c) illustrate a configuration example of an insulated transmission apparatus according to a ninth embodiment of the present invention.

FIGS. 34(a) to 34(e) illustrate a configuration example of the insulated transmission apparatus according to the ninth embodiment of the present invention.

### DESCRIPTION OF EMBODIMENTS

In the following embodiments, description is given on the basis of a plurality of divided sections or embodiment, if necessary, for the convenience of the description. However, the sections or the embodiments are associated with each other and one section or embodiment is associated with partial or entire modification examples, details, and supplementary explanations of the other sections or embodiments, except for the case in which a specific mention is given.

In addition, in the following embodiments, when an element number (including a number, a numerical value, an amount, a range, and the like) is mentioned, the element number is not limited to a specific number and may be equal to or more than the specific number or less than the specific number, except for the case in which a specific mention is given and the case in which the element number is limited to the specific number clearly in principle. In addition, in the following embodiments, it is needless to say that components (including element steps and the like) are not necessarily essential, except for the case in which a specific mention is given and the case in which the components are essential clearly in principle. Likewise, in the following embodiments, when shapes and a position relation of the components are mentioned, the shapes include shapes substantially similar to the shapes, except for the case in which a specific mention is given and the case in which the shapes similar to the shapes are not included clearly in principle. This is applicable to the numerical value and the range.

In addition, in the following embodiments, when a “conductor” is mentioned, the conductor indicates a conductive material in an electromagnetic wave frequency band to be used for transmission of an electromagnetic wave and when a “dielectric material” is mentioned, the dielectric material indicates a dielectric material in an electromagnetic wave frequency band to be used for transmission of an electromagnetic wave. Therefore, there is no direct limitation according to whether a material is a conductor, a semiconductor, or a dielectric material for a direct current. In addition, the conductor and the dielectric material are defined by characteristics thereof in a relation with the electromagnetic wave and do not limit an aspect or a constituent material such as fixation, a liquid, and a gas.

In addition, in entire drawings for describing the following embodiments, components having the same functions are denoted with the same reference numerals in principle and the repetitive description thereof is omitted. Hereinafter, embodiments of the present invention will be described in detail on the basis of the drawings.

### First Embodiment

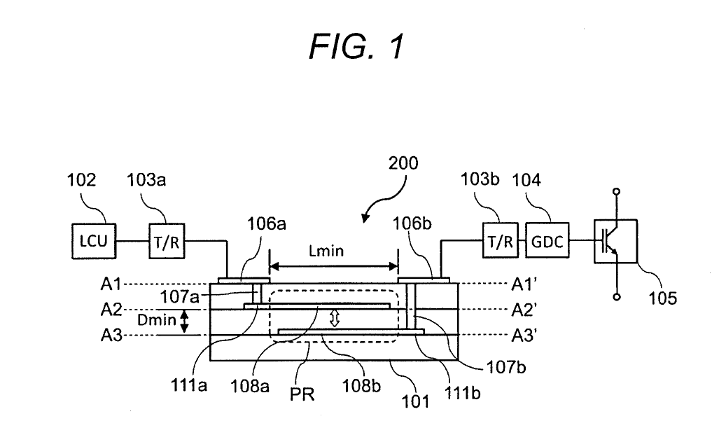

Hereinafter, an insulated transmission medium according to a first embodiment of the present invention will be described using FIGS. 1 to 7. FIG. 1 is a perspective view illustrating a configuration of an insulated transmission medium 200 according to a first embodiment of the present invention and viewed from a longitudinal cross-section and a circuit block diagram using the insulated transmission medium 200. The insulated transmission medium 200 is used for insulated communication between a gate driver circuit 104 to drive a switching element 105 of a high breakdown voltage inverter such as an IGBT and a logic control unit 102 to transmit a driving command to the gate driver circuit 104. A communication device 103a is provided between the insulated transmission medium 200 and the logic control unit 102 and a communication device 103b is provided between the insulated transmission medium 200 and the gate driver circuit 104. The communication devices 103a and 103b perform a function of converting a driving signal into a high frequency signal and inputting the high frequency signal to the insulated transmission medium 200 and a function of converting the high frequency signal output from the insulated transmission medium 200 into the driving signal again and inputting the driving signal to the gate driver circuit 104. Here, the high frequency signal can use a 2.4 GHz band to increase resistance of a communication quality for switching noise of an inverter having a frequency region to about 500 MHz. In addition, because there is a merit that a small wavelength of transmitted electromagnetic energy enables the insulated transmission medium 200 to be described below to be easily downsized, it is preferable to use the high frequency band. Here, the electromagnetic energy is electromagnetic energy exchanged through the insulated transmission medium 200, can be used as operation power of a circuit element, and includes a modulation signal such as a control signal. The insulated transmission medium 200 is configured from a dielectric material multilayer substrate 101 including a plurality of dielectric material layers. For example, a glass epoxy substrate or a ceramic substrate is used. The communication devices 103a and 103b and main resonating unit conductors 108a and 108b are connected through external interface main conductors 106a and 106b, interface main vias 107a and 107b, and internal interface main conductors 111a and 111b. Here, if the external interface main conductors 106a and 106b are non-coated bare electrodes, both of the external interface main conductors need to be isolated from each other by a minimum creeping distance Lmin or more, which is determined by a standard for safety (for example, JISC1010-1), and the minimum creeping distance is approximated by the following expression (Vop: an operation voltage of a switching element).

Lmin=4.1×Vop−1.0

This is a standard to prevent generation of so-called creeping discharge in which an arborescent discharge path is formed along a surface of a dielectric material by corona discharge or spark discharge, in the case in which two electrodes exist at a boundary of a gas and the dielectric material. Generally, because the creeping discharge is generated at an inter-electrode distance shorter than an inter-electrode distance in the space discharge and a voltage lower than a voltage in the space discharge, the creeping discharge is an important item. It is effective to coat the external interface main conductors 106a and 106b with the dielectric material to prevent the creeping discharge from being generated. As candidates of the dielectric material, solder resist materials and silicon coating materials may be exemplified. In addition, a distance Dmin between the main resonating unit conductors 108a and 108b is not defined by the standard for safety. However, it is preferable to provide a dielectric material having a thickness of 0.4 mm or more. In processing of a printed substrate such as a glass epoxy substrate, because the thickness of the dielectric material can be increased to about several mm, sufficient insulation performance having considered long-term insulation reliability as an insulator is obtained. The dielectric breakdown resistance of the glass epoxy substrate as a reference is about 30 kV/mm, a performance confirmation by an acceleration test such as a thermal cycle test and a constant-temperature constant-humidity test is performed in consideration of the dielectric breakdown resistance and the long-term insulation reliability, and Dmin is set.

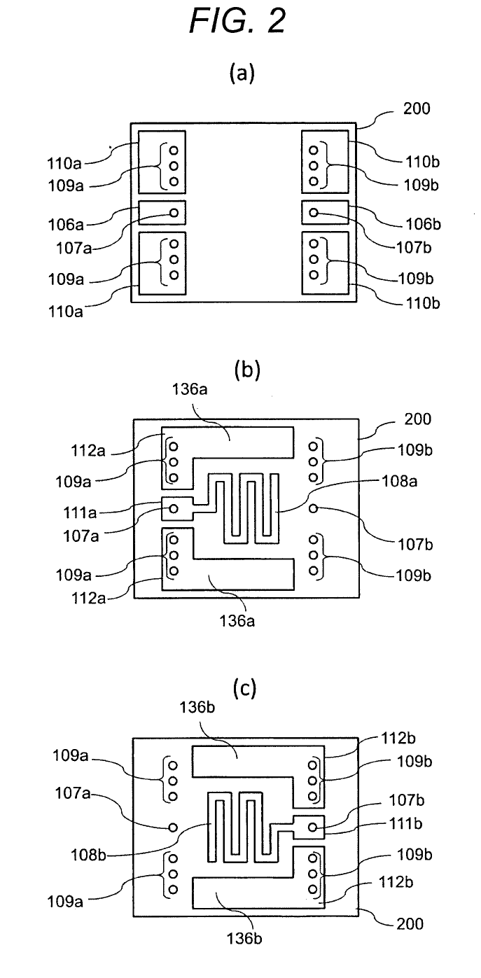

FIGS. 2(a), 2(b), and 2(c) are horizontal cross-sectional views taken along a surface A1-A1′, a surface A2-A2′, and a surface A3-A3′ of the dielectric material multilayer substrate 101 of FIG. 1, respectively. A coplanar line configured by the external interface main conductor 106a and the external interface auxiliary conductor 110a is converted into an equivalent coplanar line configured by the interface main via 107a and the interface auxiliary via 109a horizontally and vertically, is converted into a coplanar line configured by the internal interface main conductor 111a and the internal interface auxiliary conductor 112a vertically and horizontally, and is connected to the first resonator configured from the main resonating unit conductor 108a and the auxiliary resonating unit conductor 136a and having a first reference potential. The main resonating unit conductor 108a and the auxiliary resonating unit conductor 136a resonate in a frequency band of a high frequency signal and are resonantly coupled to the second resonator configured from the main resonating unit conductor 108b and the auxiliary resonating unit conductor 136b isolated by the dielectric material and having a second reference potential different from the first reference potential. Here, a conductor of a zigzag shape obtained by bending a straight line several times, for example, a meander line is used as the main resonating unit conductor, current directions of the conductors adjacent to each other become opposite to each other to cancel an antenna radiation component, and an electromagnetic wave leakage to the outside of the dielectric material multilayer substrate 101 is suppressed small. In addition, the auxiliary resonating unit conductors 136a and 136b have a function of decreasing an electromagnetic wave leakage to the outside of the main resonating unit conductors 108a and 108b. A modification example of the resonator will be described below. The main resonating unit conductor 108b and the auxiliary resonating unit conductor 136b are connected to a coplanar line configured by the internal interface main conductor 111b and the internal interface auxiliary conductor 112b and is connected to the communication device 103b through the equivalent coplanar line configured by the interface main via 107b and the interface auxiliary via 109b and the coplanar line configured by the external interface main conductor 106b and the external interface auxiliary conductor 110b. Here, a transmission line functioning as an interface is configured to have a coplanar shape, so that the number of conductors to be used is decreased. In addition, it is needless to say that the minimum creeping distance described above is equally applicable to the external interface auxiliary conductors 110a and 110b and coating by the dielectric material is effective.

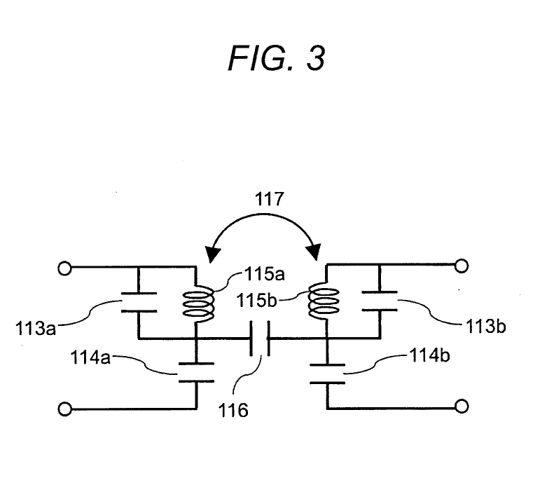

FIG. 3 is an equivalent circuit diagram in a region PR of FIG. 1. A self-induction component 115a comes from lines of the main resonating unit conductor 108a and a capacitance component 113a comes from capacitance between the lines of the main resonating unit conductor 108a. In addition, a capacitance component 114a comes from capacitance between the main resonating unit conductor 108a and the auxiliary resonating unit conductor 112a. Resonance is generated at a certain frequency by the capacitance components 113a and 114a and the self-induction component 115a. Similar to the above, capacitance components 113b and 114b and a self-induction component 115b come from a resonator structure and resonance is generated at a certain frequency. When resonance frequencies of two resonance circuits are matched with each other, resonance coupling is realized by a capacitance component 116 and a mutual induction component 117 between the main resonating unit conductors 108a and 108b and high-efficiency electromagnetic energy transmission can be realized. In addition, because of transmission using the resonance, this structure has a characteristic of a band pass filter and can improve resistance of a communication quality for switching noise of an inverter of a low frequency region. The capacitance component 116 comes from capacitance between the auxiliary resonating unit conductors 136a and 136b and an overlapping area of the auxiliary resonating unit conductors 136a and 136b viewed from a surface direction of the dielectric material multilayer substrate 101 increases. Alternatively, when a distance between the auxiliary resonating unit conductors 136a and 136b decreases, the capacitance component increases and a coupling amount also increases. However, because the increase in the capacitance component 116 increases a noise current by switching of the inverter, the capacitance component needs to be suppressed to about 10 pF or less.

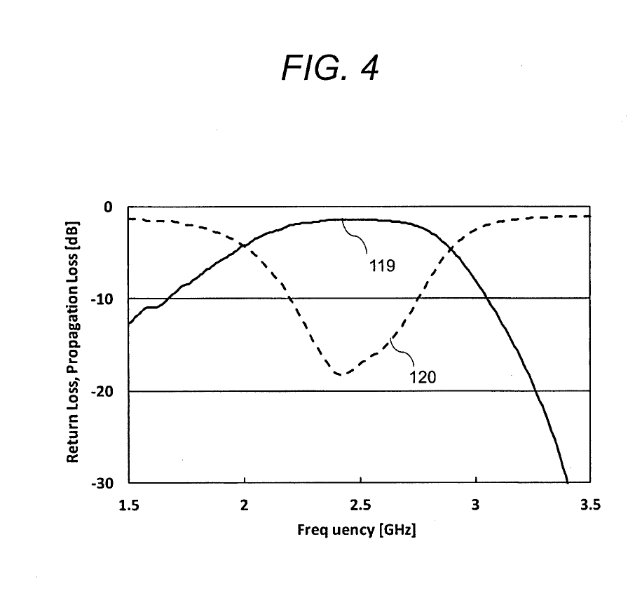

FIG. 4 illustrates an actual measurement result of frequency characteristics of a reflection amount and a passage amount of the insulated transmission medium as an example of a design. A design frequency is set to 2.4 GHz. At the time of measurement, a network analyzer is used. At 2.4 GHz, numerical values of −18.2 dB and −1.4 dB are obtained as a reflection amount 120 and a passage amount 119, respectively. In addition, in a range from 2.2 GHz to 2.75 GHz, a reflection amount becomes −10 dB or less and a numerical value of 0.55 GHz is obtained as an operation bandwidth.

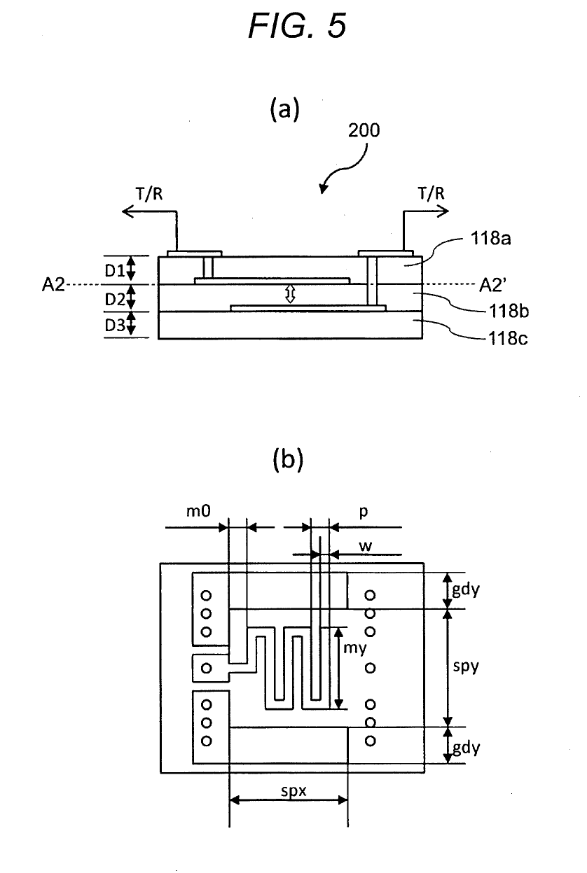

In FIG. 5(a) illustrating design parameters in a perspective view viewed from a longitudinal cross-section of the insulated transmission medium 200, in a pre-production sample used for this actual measurement, a silicon coating material having a thickness D1=D3=0.5 mm of the dielectric material layers 118a and 118c, relative permittivity ∈r1=∈r3=2.7, and a dielectric tangent tan δ1=tan δ3=0.001 and a glass epoxy material having a thickness D2=2.4 mm of the dielectric material layer 118b, relative permittivity ∈r2=4.2, and a dielectric tangent tan δ2=0.02 are used. In addition, in FIG. 5(b) illustrating design parameters in a horizontal cross-sectional view taken along the surface A2-A2′ of the dielectric material multilayer substrate 101, a pitch of a meander line becoming the main resonating unit is set to p=0.4 [mm], a line width of the meander line is set to w=0.12 [mm], an entire horizontal width of the meander line is set to my=5.92 [mm], a length of an extraction line is set to m0=4.14 [mm], a width of the auxiliary resonating unit is set to gdy=1.5 [mm], a length of the auxiliary resonating unit is set to spx=10 [mm], and an interval between the auxiliary resonating units is set to spy=12 [mm].

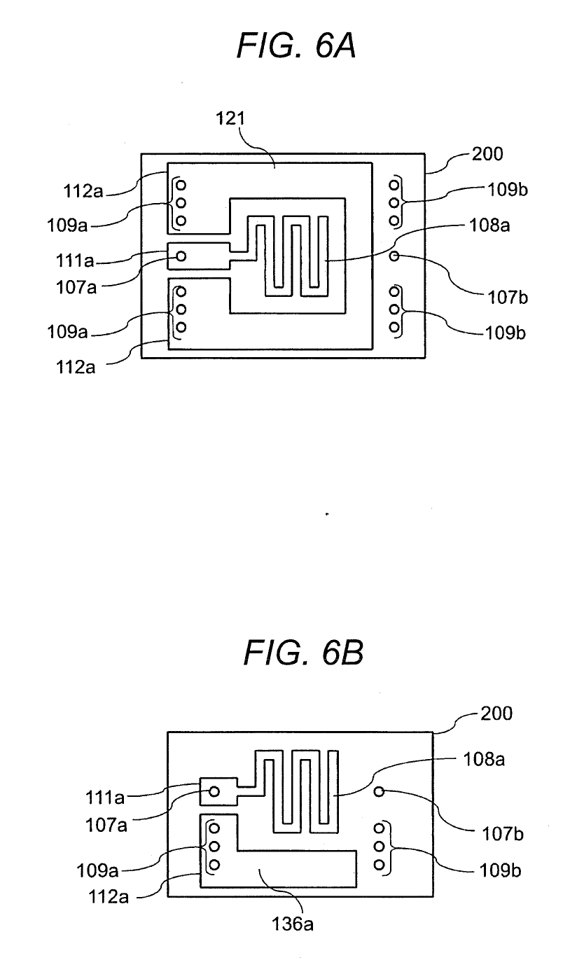

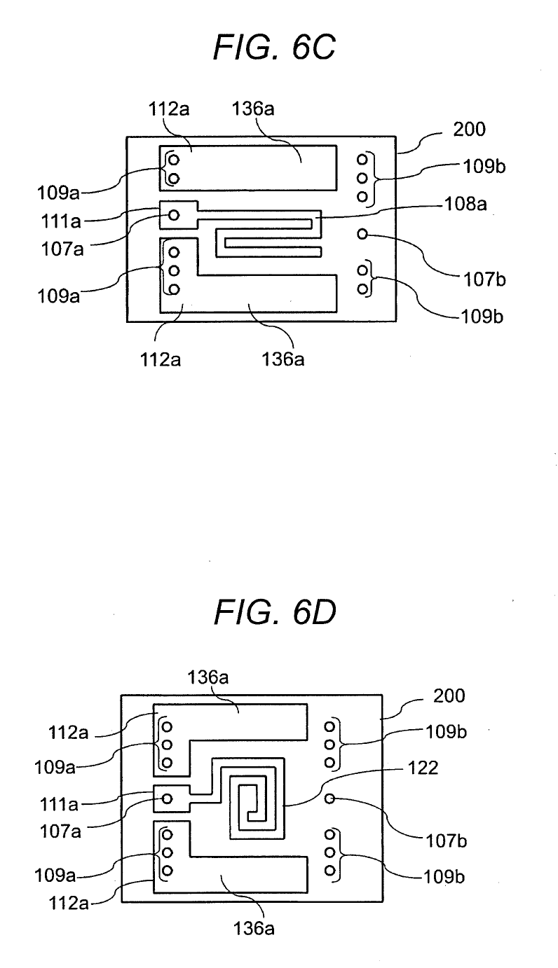

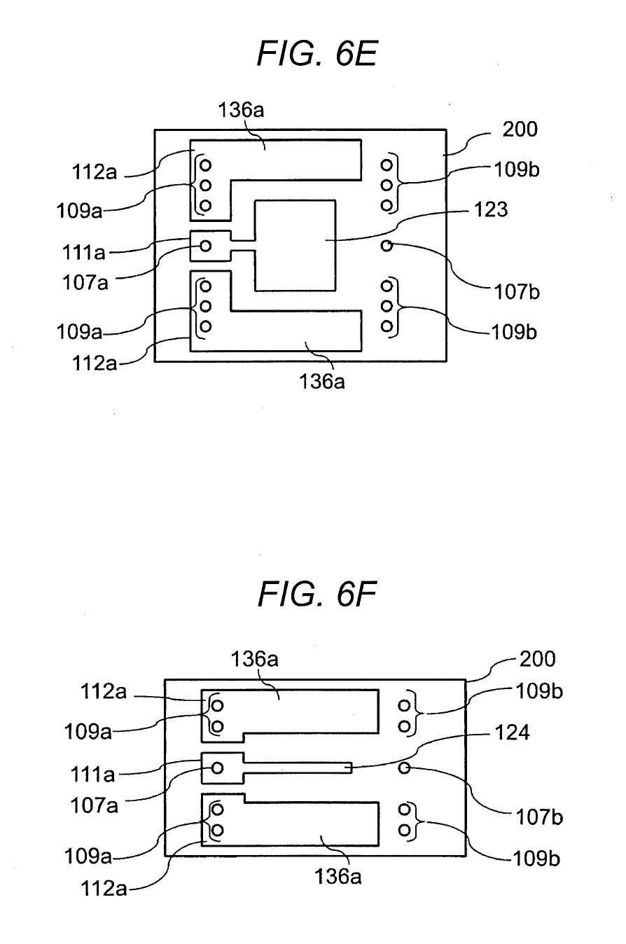

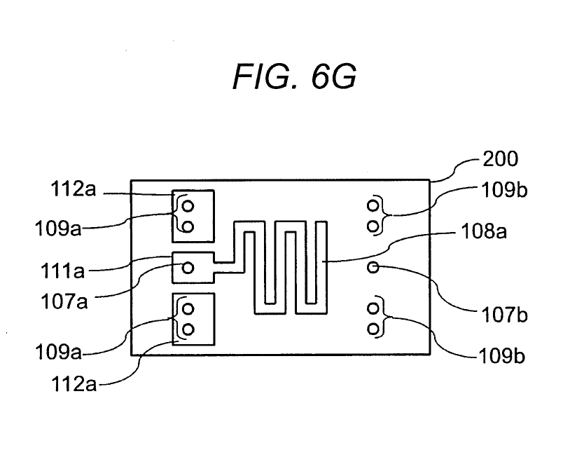

FIGS. 6A to 6G are diagrams illustrating modification examples of the resonator of the insulated transmission medium 200 and correspond to the horizontal cross-sectional view taken along the surface A2-A2′ of the dielectric material multiplayer substrate 101 of FIG. 1. FIG. 6A illustrates a modification example where the main resonating unit conductor 108a is surrounded by the auxiliary resonating unit conductor 121 to decrease an electromagnetic wave leakage to the outside of the main resonating unit conductor 108a.

FIG. 6B illustrates a modification example where the auxiliary resonating unit conductor 136a is arranged at only one side of the main resonating unit conductor 108a to decrease an area of the insulated transmission medium 200.

FIG. 6C illustrates a modification example where a zigzag direction of the meander line of the main resonating unit conductor 108a is changed to decrease the area of the insulated transmission medium 200. In addition, because an aspect ratio of the insulated transmission medium 200 is changed from a surface of the dielectric material multilayer substrate 101, the modification is effective for decreasing an area when a plurality of resonators to be described below are arranged in parallel.

FIG. 6D illustrates a modification example in which a conductor having a spiral shape is used as the main resonating unit conductor 122. The self-induction component 115a and the mutual induction component 117 in the equivalent circuit of FIG. 3 increase and high transmission efficiency is obtained.

FIG. 6E illustrates a modification example where a conductor having a rectangular shape is used as the main resonating unit conductor 123. The capacitance component 116 in the equivalent circuit of FIG. 3 increases and high transmission efficiency is obtained. Here, a shape is a rectangular shape. However, even though the shape is a circular shape or a trapezoidal shape, the same effect is obtained. FIG. 5F illustrates a modification example where a conductor having an elongated line shape is used as the main resonating unit conductor 124 and an area of the insulated transmission medium 200 is decreased.

FIG. 6G illustrates a modification example where the auxiliary resonating unit conductor is removed, a coupling ratio of the mutual induction component is increased, and the area of the insulated transmission medium 200 is decreased.

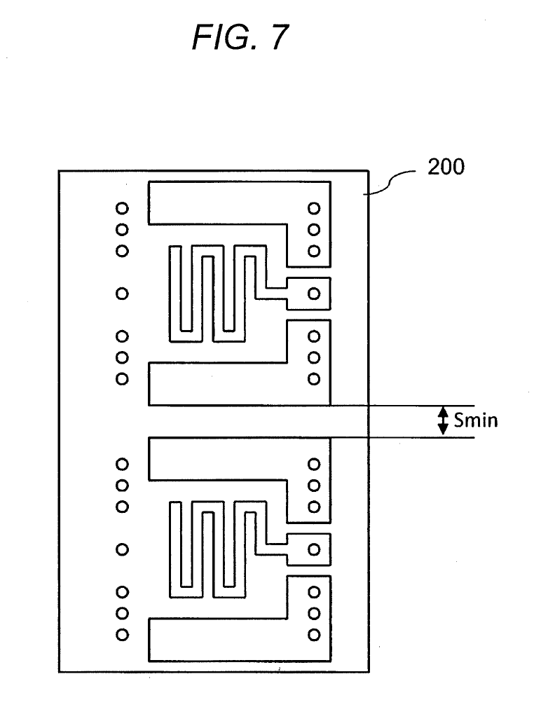

FIG. 7 is a diagram illustrating the insulated transmission medium 200 in which the resonators are provided in parallel in the same dielectric material multilayer substrate. A plurality of switching elements can be controlled by one dielectric material multilayer substrate.

When a control signal is transmitted to the plurality of switching elements, it is necessary to isolate the resonators from each other by Smin in consideration of a potential difference between the switching elements at the time of an operation. Because Smin is an inter-electrode distance in the dielectric material, Smin can be considered similarly to Dmin described above and it is preferable to provide a dielectric material having a thickness of 0.4 mm or more. At the time of practical use, a performance confirmation by an acceleration test such as a thermal cycle test and a constant-temperature constant-humidity test is performed in consideration of the operation voltage or the long-term insulation reliability and Smin is set. When a plurality of resonators are used for insulated transmission with one switching element, Smin is not limited to the above value. For example, there are control signal transmission and state signal transmission of the switching element therefor or the control signal transmission and power transmission to the gate driver circuit.

As described above, the insulated transmission medium 200 according to the first embodiment has the dielectric material multilayer substrate 101 that includes the plurality of dielectric material layers 118, the first resonators 108a and 136a that are provided on the substrate 101 and have the first reference potential, and the second resonators 108b and 136b that are provided on the substrate 101, have the second reference potential different from the first reference potential, and are electrically insulated from the first resonators and the electromagnetic energy is transmitted between the first resonators and the second resonators. In particular, the first resonators include the first main resonating unit 108a and the first auxiliary resonating unit 136a and the second resonators include the second main resonating unit 108b and the second auxiliary resonating unit 136b.

The insulated transmission medium 200 according to the present invention described in this embodiment is used to transmit the electromagnetic energy between the circuits having the different reference potentials and the resonators connected to the individual circuits are arranged to be isolated from each other in the dielectric material multilayer substrate, so that high-efficiency electromagnetic energy transmission can be realized between the dielectric materials having the thickness at which insulation reliability can be maintained over a long period.

In addition, according to the first embodiment, because the insulated communication can be realized without using an optical fiber to be the related art, downsizing is enabled as an inverter system. In addition, because the insulated transmission medium 200 can be manufactured by processing a general-purpose printed substrate, a cost can be decreased.

In addition, according to this embodiment, because the insulated transmission medium 200 can transmit the high frequency signal, the resistance of the communication quality for the switching noise of the inverter having the frequency region to about 500 MHz can be increased. Because of the transmission using the resonance, this structure has the characteristic of the band pass filter, the noise resistance can be further increased, and a reliable inverter operation is enabled.

In addition, the first embodiment has been mainly described as the insulated communication. However, the communication device 103a can be replaced by a power transmission circuit and the communication device 103b can be replaced by a power reception circuit to be used for insulated feeding to the gate driver circuit 104. Of course, it is needless to say that transmitting both sides simultaneously or time divisionally can be realized by a combination configuration.

### Second Embodiment

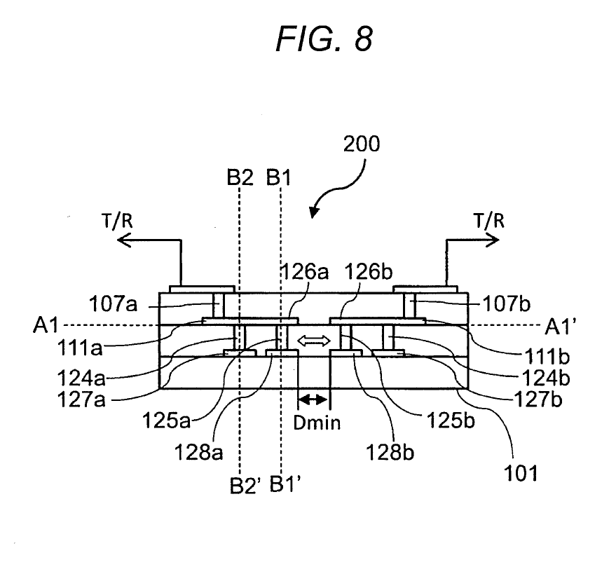

Hereinafter, an insulated transmission medium according to a second embodiment of the present invention will be described using FIGS. 8 to 10(c). FIG. 8 is a perspective view illustrating a configuration of an insulated transmission medium 200 and viewed from a longitudinal cross-section. A circuit block using the insulated transmission medium 200 is the same as that of the first embodiment or FIG. 1.

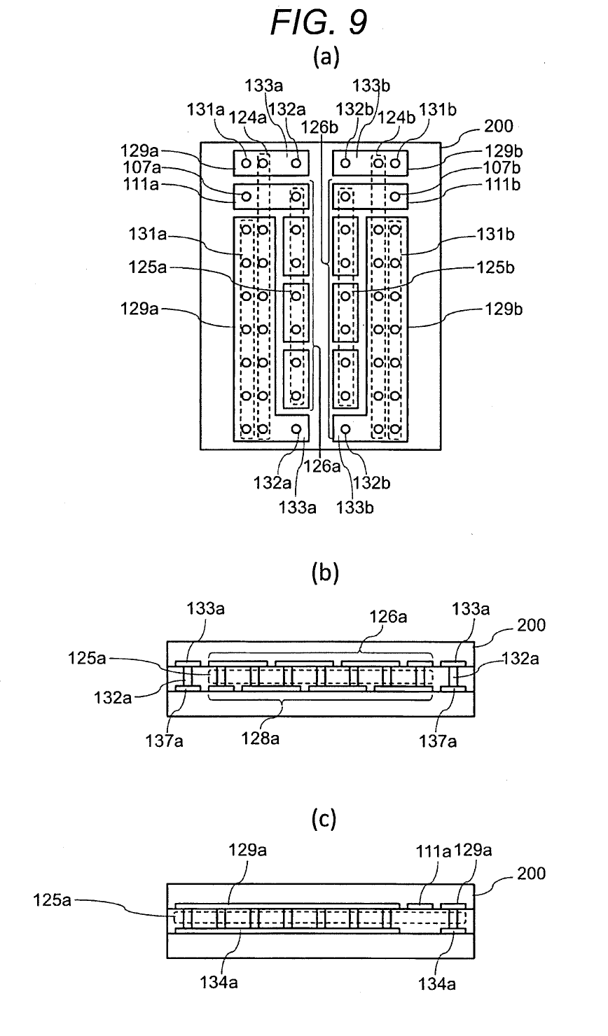

FIGS. 9(a), 9(b), and 9(c) are a horizontal cross-sectional view taken along a surface A1-A1′ of a dielectric material multilayer substrate 101 of FIG. 8 and longitudinal cross-sectional views taken along a surface B1-B1′ and a surface B2-B2′ thereof, respectively. A meander line is configured in a direction of a longitudinal cross-section of the dielectric material multilayer substrate, by main resonating unit conductors 126a and 128a and a resonator main via 125a. As conductors surrounding the meander line, auxiliary resonating unit conductors 133a and 137a and a resonator auxiliary via 132a are configured. However, capacitance between the meander line and an internal interface auxiliary conductor 129a and an internal interface auxiliary via 124a is also included as the capacitance component 114a of FIG. 3. The meander line and the conductors surrounding the meander line resonate in a frequency band of a high frequency signal and are resonantly coupled to the other resonator isolated by a dielectric material. Here, the meander line of a zigzag shape is used as the main resonating unit conductor, current directions of the conductors adjacent to each other become opposite to each other to cancel an antenna radiation component, and an electromagnetic wave leakage to the outside of the dielectric material multilayer substrate 101 is suppressed small. In addition, the conductor surrounding the meander line has a function of decreasing an electromagnetic wave leakage from the meander line to the outside. In addition, different from the first embodiment, in this embodiment, because the two resonators are arranged in a direction of a substrate surface of the dielectric material multilayer substrate 101, it is not necessary to increase a thickness of a dielectric material layer of the dielectric material multilayer substrate in consideration of insulation reliability and a size can be decreased. However, similar to the first embodiment, it is preferable to provide a dielectric material having a thickness of 0.4 mm or more, with respect to a distance Dmin between the resonators.

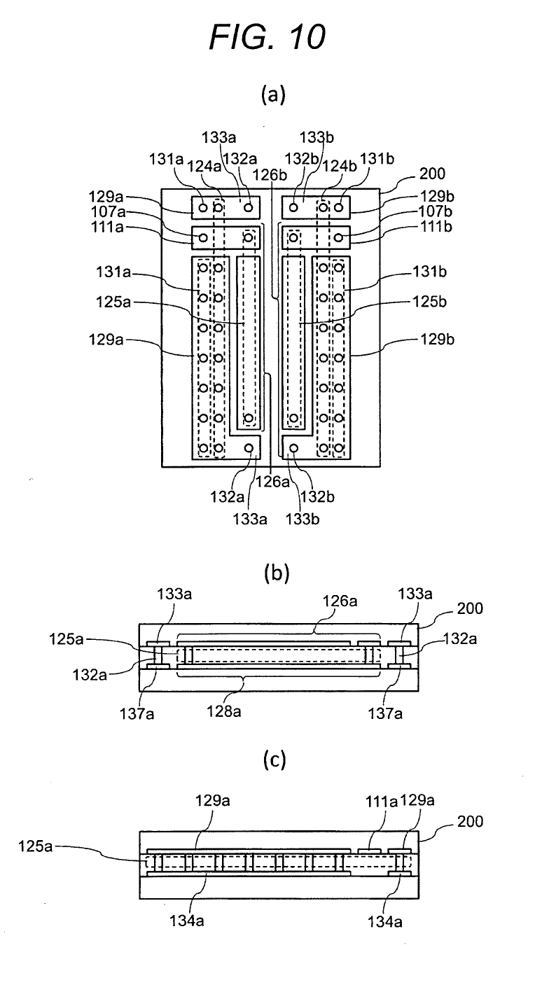

FIGS. 10(a), 10(b), and 10(c) are a horizontal cross-sectional view taken along the surface A1-A1′ of the dielectric material multilayer substrate 101 of FIG. 8 and longitudinal cross-sectional views taken along the surface B1-B1′ and the surface B2-B2′ thereof, respectively, and illustrate a modification example of the insulated transmission medium 200. A spiral line is configured in a direction of a longitudinal cross-section of the dielectric material multilayer substrate, by the main resonating unit conductors 126a and 128a and the resonator main via 125a. As conductors surrounding the spiral line, the auxiliary resonating unit conductors 133a and 137a and the resonator auxiliary via 132a are configured. Similar to the above, capacitance between the spiral line and the internal interface auxiliary conductor 129a and the internal interface auxiliary via 124a is also included as the capacitance component 114a of FIG. 3. The spiral line and the conductors surrounding the spiral line resonate in a frequency band of a high frequency signal and are resonantly coupled to the other resonator isolated by a dielectric material. The self-induction component 115a and the mutual induction component 117 in the equivalent circuit of FIG. 3 increase, so that high transmission efficiency is obtained.

As described above, in the insulated transmission medium 200 according to the second embodiment, it is not necessary to increase the thickness of the dielectric material layer of the dielectric material multilayer substrate in consideration of the insulation reliability and a size can be decreased, in addition to the effects according to the first embodiment.

### Third Embodiment

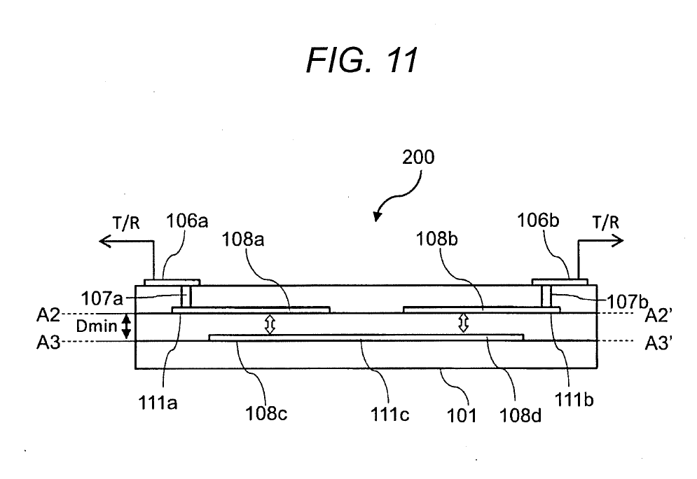

Hereinafter, an insulated transmission medium according to a third embodiment of the present invention will be described using FIGS. 11 to 13(b). FIG. 11 is a perspective view illustrating a configuration of an insulated transmission medium 200 and viewed from a longitudinal cross-section. A circuit block using the insulated transmission medium 200 is the same as that of the first embodiment or FIG. 1. A communication device and main resonating unit conductors 108a and 108b are connected through external interface main conductors 106a and 106b and interface main vias 107a and 107b, and internal interface main conductors 111a and 111b. Main resonating unit conductors 108c and 108d are arranged to face the main resonating unit conductors 108a and 108b and the main resonating unit conductors 108c and 108d are connected by an internal interface main conductor 111c. Because the main resonating unit conductors 108c and 108d are in a floating state in which the main resonating unit conductors are not physically connected to other elements, a potential thereof becomes an intermediate potential and a voltage applied between the main resonating unit conductors 108a and 108c can be suppressed to ½ of a voltage applied between the main resonating unit conductors 108a and 108b. Therefore, a distance Dmin between the main resonating unit conductors 108a and 108c or between the main resonating unit conductors 108b and 108d can be decreased and a size of the insulated transmission medium 200 can be decreased. In addition, transmission efficiency between the resonators can be improved and an electromagnetic wave leakage to the outside can be decreased.

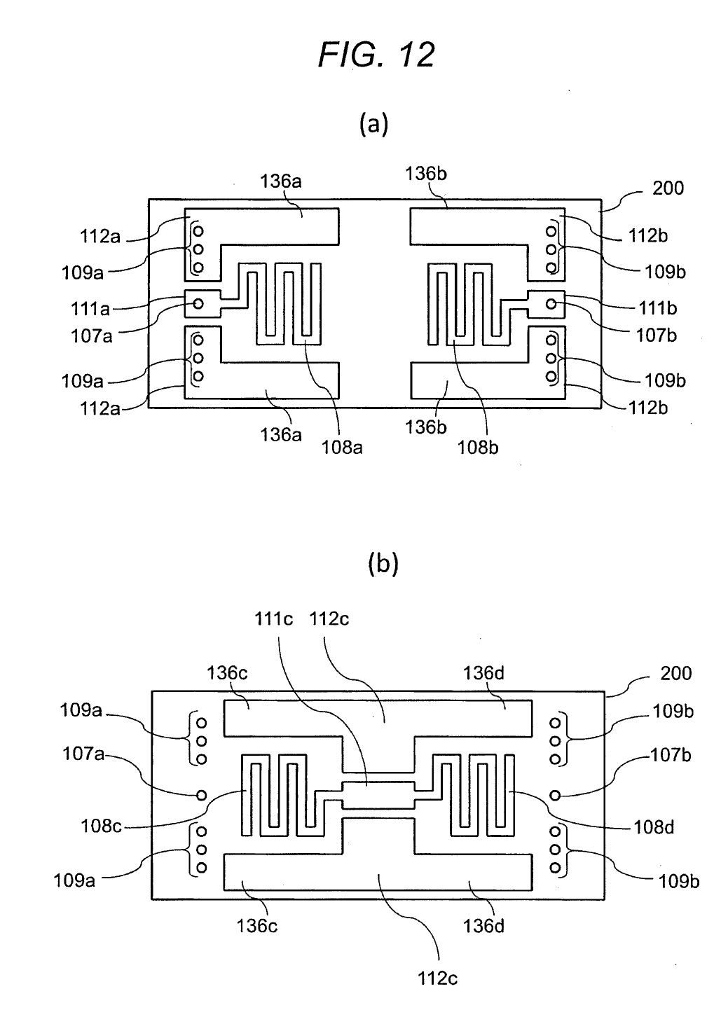

FIGS. 12(a) and 12(b) are horizontal cross-sectional views taken along a surface A2-A2′ and a surface A3-A3′ of a dielectric material multilayer substrate 101 of FIG. 11, respectively. An equivalent coplanar line configured from the interface main via 107a and an interface auxiliary via 109a is converted into a coplanar line configured from the internal interface main conductor 111a and an internal interface auxiliary conductor 112a vertically and horizontally and is connected to the main resonating unit conductor 108a and an auxiliary resonating unit conductor 136a. The main resonating unit conductor 108a and the auxiliary resonating unit conductor 136a resonate in a frequency band of a high frequency signal and are resonantly coupled to the main resonating unit conductor 108c and an auxiliary resonating unit conductor 136c isolated by a dielectric material. Here, a meander line is used as the main resonating unit, current directions of the conductors adjacent to each other become opposite to each other to cancel an antenna radiation component, and an electromagnetic wave leakage to the outside of the dielectric material multilayer substrate 101 is suppressed small. In addition, the auxiliary resonating unit conductors 136a and 136c have a function of decreasing an electromagnetic wave leakage to the outside of the main resonating unit conductors 108a and 108c. The resonator may use the modification example described in FIGS. 6A to 6G. The main resonating unit conductor 108c and the auxiliary resonating unit conductor 136c are connected to the main resonating unit conductor 108d and the auxiliary resonating unit conductor 136d through a coplanar line configured from the internal interface main conductor 111c and the internal interface auxiliary conductor 112c. The main resonating unit conductor 108d and the resonator auxiliary conductor 136d resonate in a frequency band of a high frequency signal and are resonantly coupled to the main resonating unit conductor 108b and an auxiliary resonating unit conductor 136b isolated by a dielectric material. The main resonating unit conductor 108b and the auxiliary resonating unit conductor 136b is connected to a coplanar line configured from the internal interface main conductor 111b and the internal interface auxiliary conductor 112b and is connected to a communication device through an equivalent coplanar line configured from the interface main via 107b and the interface auxiliary via 109b and a coplanar line configured from the external interface main conductor 106b and the external interface auxiliary conductor 110b. Here, a transmission line functioning as an interface is configured to have a coplanar shape, so that the number of conductor layers to be used is decreased. Each resonance coupling can be described with reference to the equivalent circuit diagram of FIG. 3, similar to the first embodiment. In addition, two sets of resonators arranged to face each other are connected in series, so that a capacitance component having a big influence on a noise current by switching of an inverter can be decreased to about ½.

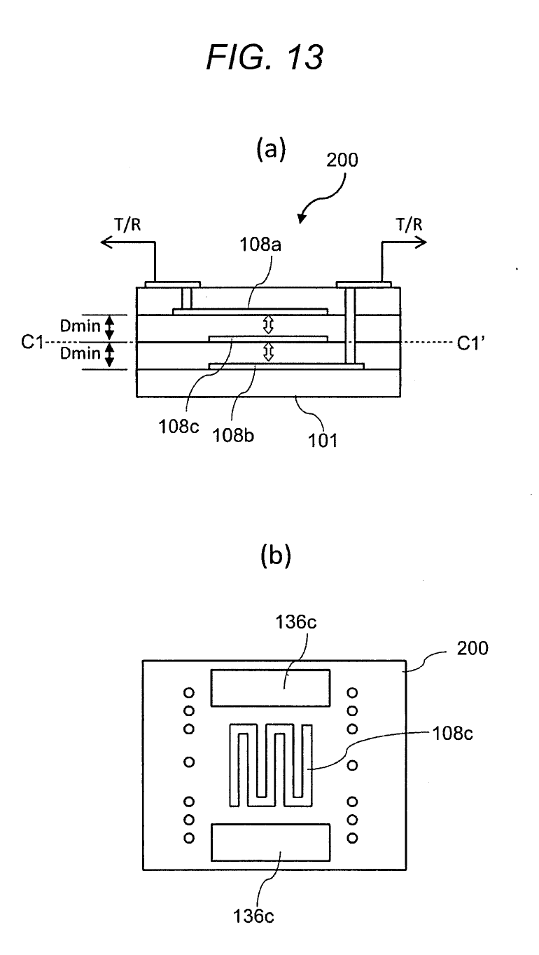

FIG. 13(a) is a perspective view illustrating a configuration of the insulated transmission medium 200 and viewed from a longitudinal cross-section and illustrates a modification example of the third embodiment. The insulated transmission medium 200 is configured from the dielectric material multilayer substrate 101 including the plurality of dielectric material layers. The communication device and the main resonating unit conductors 108a and 108b are physically connected to each other and the main resonating unit conductor 108c is arranged to be interposed by the main resonating unit conductors 108a and 108b. In the configuration of this modification example, an area of the dielectric material multilayer substrate 101 can be decreased by connecting the three resonators in series in a lamination direction of the dielectric material substrate, in addition to the effects according to the third embodiment.

FIG. 13(b) is a horizontal cross-sectional view taken along the surface C1-C1′ of the dielectric material multilayer substrate 101 of FIG. 13 (a). A floating resonator is configured by the main resonating unit conductor 108c and the auxiliary resonating unit conductor 136c. By connecting the three resonators in series, a capacitance component having a big influence on a noise current by the switching of the inverter can be decreased to about ½, in addition to the effects according to the second embodiment.

As described above, in the insulated transmission medium 200 according to the second embodiment, the distance Dmin between the main resonating unit conductors 108a and 108c or between the main resonating unit conductors 108b and 108d can be decreased and a size of the insulated transmission medium 200 can be decreased, in addition to the effects according to the first embodiment.

### Fourth Embodiment

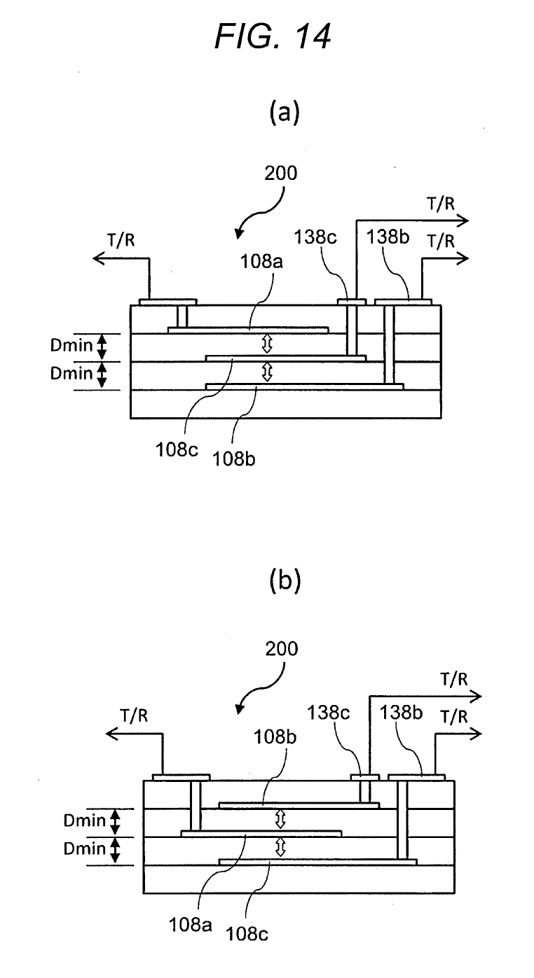

Hereinafter, an insulated transmission medium according to a fourth embodiment of the present invention will be described using FIGS. 14(a) to 16B. FIG. 14(a) is a perspective view illustrating a configuration of an insulated transmission medium 200 and viewed from a longitudinal cross-section. A circuit block using the insulated transmission medium 200 is similar to the circuit block of FIG. 1. However, the circuit block is different from the circuit block of FIG. 1 in that driving commands for two switching elements are transmitted from a communication device of a logic control unit side. The communication device and main resonating unit conductors 108a, 108b, and 108c are physically connected to each other and the main resonating unit conductor 108c is arranged to be interposed by the main resonating unit conductors 108a and 108b. The main resonating unit may use the meander line described in the first embodiment or the modification examples described in FIGS. 6A and 6B. In order to transmit a control signal to a plurality of switching elements, it is preferable to isolate external interface conductors 138b and 138c from each other in consideration of an operation voltage or long-term insulation reliability at the time of practical use. Of course, the isolation distance may be small, when a plurality of resonators are used for insulated transmission with one switching element. For example, there are control signal transmission and state signal transmission of the switching element therefor or the control signal transmission and power transmission to a gate driver circuit. In this embodiment, because a coupling ratio from the main resonating unit conductor 108a to the main resonating unit conductor 108c and a coupling ratio from the main resonating unit conductor 108a to the main resonating unit conductor 108b through the main resonating unit conductor 108c can be easily changed by a design of a resonator structure, the fitness to the purposes such as the control signal transmission and the power transmission in which energy ratios are greatly different from each other is high.

FIG. 14(b) is a perspective view illustrating a configuration of the insulated transmission medium 200 and viewed from a longitudinal cross-section and illustrates a modification example of the fourth embodiment. As compared with the configuration of FIG. 14 (b), in the configuration of FIG. 14 (a), the same coupling ratios from the main resonating unit conductor 108a to the main resonating unit conductors 108b and 108c can be easily realized and the fitness to the purpose for transmitting a control signal to the two switching elements is high. Of course, overlapping the control signal transmission and the state signal transmission of the switching element therefor or overlapping the control signal transmission and the power transmission to the gate driver circuit is enabled.

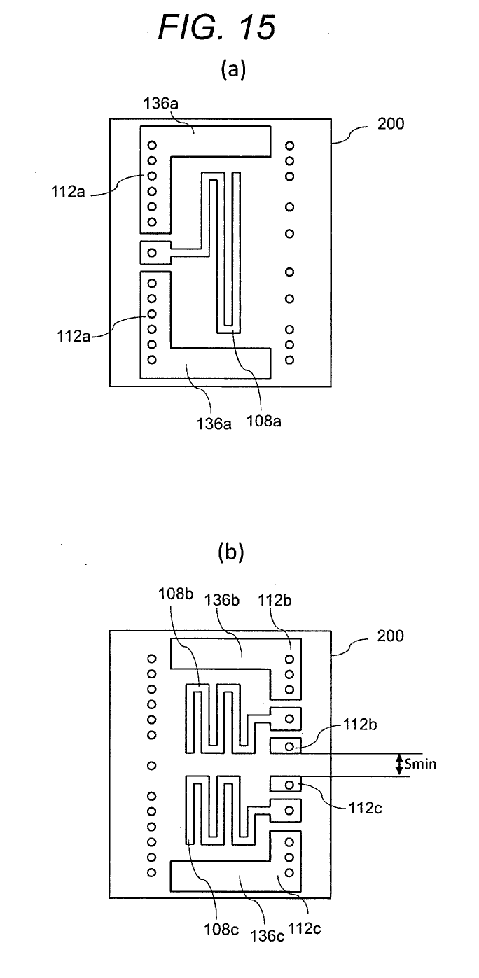

FIGS. 15A and 15B illustrate a first modification example of the fourth embodiment. For example, FIGS. 15A and 15B are diagrams corresponding to horizontal cross-sections of the surface A2-A2′ and the surface A3-A3′ of the dielectric material multilayer substrate 101 in FIG. 1. A structure in which two resonators respectively configured from the main resonating unit conductor 108b and an auxiliary resonating unit conductor 136b and the main resonating unit conductor 108c and an auxiliary resonating unit conductor 136c are resonantly coupled to one resonator configured from the main resonating unit conductor 108a and an auxiliary resonating unit conductor 36a is arranged in the dielectric material multilayer substrate. The shapes of the resonator configured from the main resonating unit conductor 108b and the auxiliary resonating unit conductor 136b and the resonator configured from the main resonating unit conductor 108c and the auxiliary resonating unit conductor 136c are changed, so that the coupling ratios can be easily changed. Therefore, overlapping the control signal transmission and the power transmission to the gate driver circuit can be applied. In addition, overlapping the control signal transmission to the plurality of switching elements or the control signal transmission and the state signal transmission of the switching element therefor is enabled.

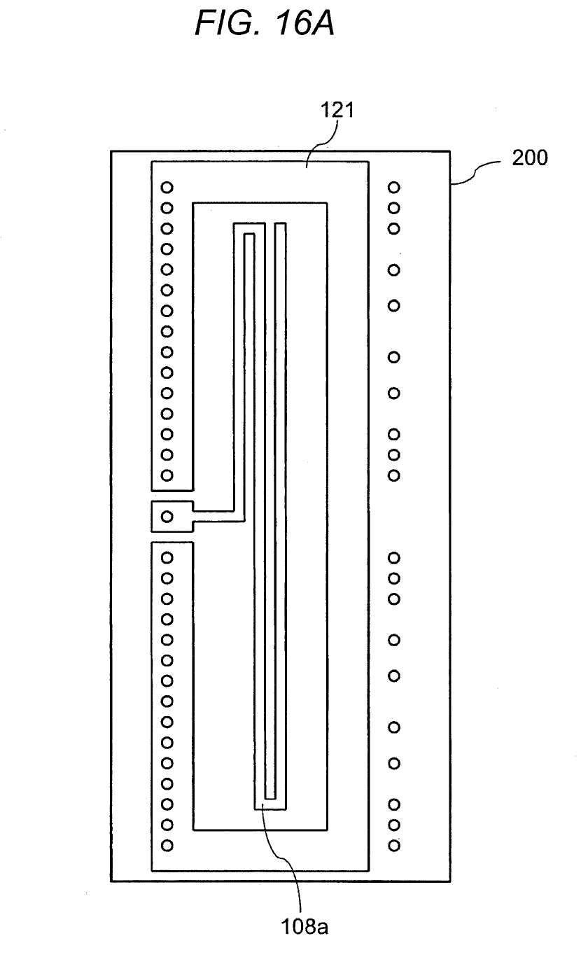

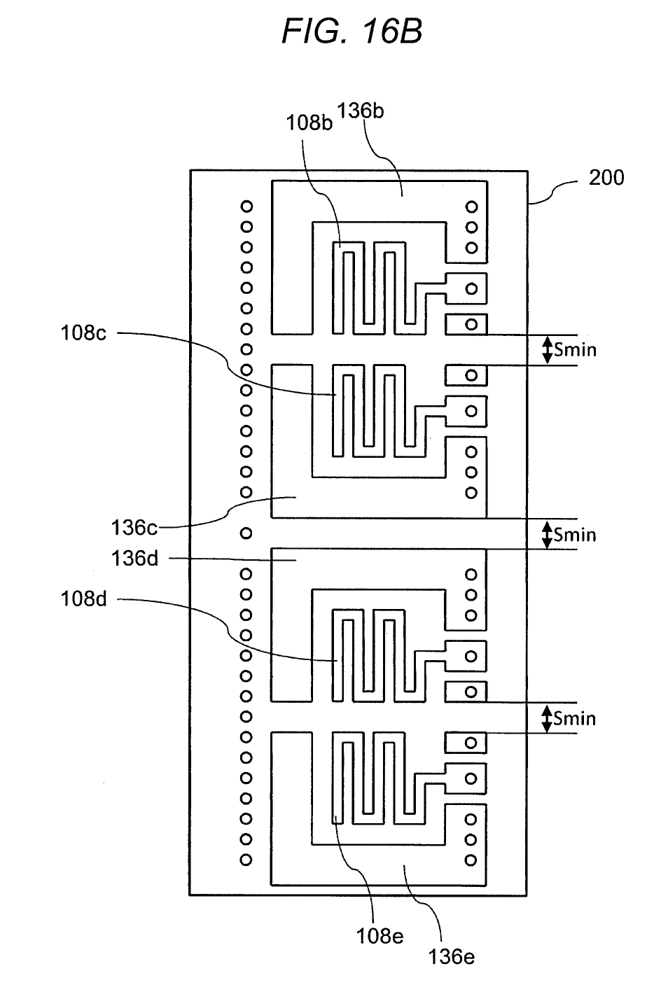

FIGS. 16A and 16B illustrate a second modification example of the fourth embodiment. For example, FIGS. 16A and 16B are diagrams corresponding to horizontal cross-sections of the surface A2-A2′ and the surface A3-A3′ of the dielectric material multilayer substrate 101 in FIG. 1 corresponding to the first embodiment. A structure in which four resonators respectively configured from the main resonating unit conductor 108b and the auxiliary resonating unit conductor 136b, the main resonating unit conductor 108c and the auxiliary resonating unit conductor 136c, a main resonating unit conductor 108d and an auxiliary resonating unit conductor 136d, and a main resonating unit conductor 108e and an auxiliary resonating unit conductor 136e are resonantly coupled to one resonator configured from the main resonating unit conductor 108a and the auxiliary resonating unit conductor 121 is arranged in the dielectric material multilayer substrate. The shapes of the resonator configured from the main resonating unit conductor 108b and the auxiliary resonating unit conductor 136b, the resonator configured from the main resonating unit conductor 108c and the auxiliary resonating unit conductor 136c, the resonator configured from the main resonating unit conductor 108d and the auxiliary resonating unit conductor 136d, and the resonator configured from the main resonating unit conductor 108e and the auxiliary resonating unit conductor 136e are changed, so that the coupling ratios can be easily changed. Therefore, overlapping the control signal transmission and the power transmission to the gate driver circuit can be applied.

As described above, the insulated transmission medium 200 according to the fourth embodiment is used to transmit the electromagnetic energy between the three or more circuits having the different reference potentials, the resonators connected to the individual circuits are arranged to be isolated from each other in a direction of a substrate surface in the dielectric material multilayer substrate, and one resonator and the plurality of resonators are resonantly coupled to each other. Therefore, in addition to the effects according to the first embodiment, a plurality of types of transmissions such as control signal transmission, state signal transmission, and operation power transmission are enabled.

In addition, in the fourth embodiment, one resonator and a plurality of resonators are resonantly coupled to each other. However, a plurality of resonators and a plurality of resonators can be resonantly coupled to each other, using the same principle.

### Fifth Embodiment

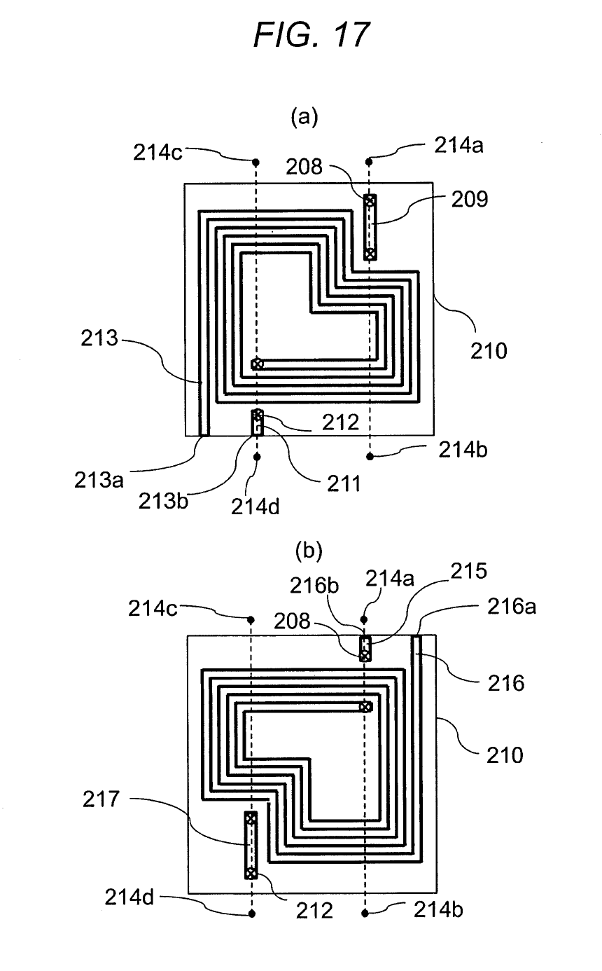

Hereinafter, an insulated transmission medium according to a fifth embodiment of the present invention configured by two conductor layers and three dielectric material layers will be described using FIGS. 17(a) to 27(b) and FIGS. 32(a) and 32 (b).

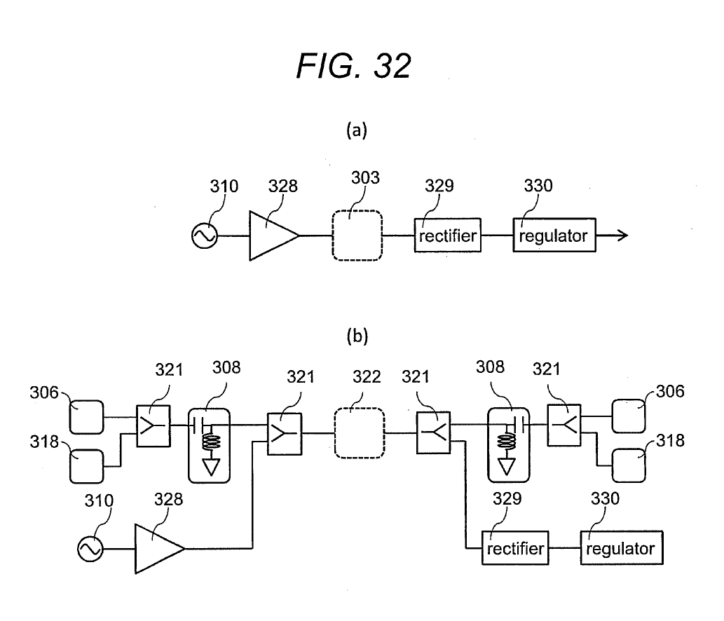

FIG. 32(a) illustrates a configuration example of an insulated power transmission apparatus when power transmission is performed and illustrates an inverter gate driver power supply unit including the insulated transmission medium according to the fifth embodiment and a peripheral circuit. An oscillation circuit 310 generates a frequency when a direct-current voltage is applied and outputs an alternating-current signal. The output alternating-current signal is amplified by an amplification circuit 328 and is input to an insulated transmission medium 303. The alternating-current signal is rectified by a rectification circuit 329 via the insulated transmission medium 303. An obtained voltage/current component is adjusted to a desired level by a regulator 330 and is supplied as power to a gate driver circuit. An oscillation frequency generated by the oscillation circuit 310 is determined in consideration of transmission efficiency of the insulated transmission medium 303, an interference suppression amount for inverter surge noise in the insulated transmission medium, and insulating resistance of the insulated transmission medium, and rectification efficiency of the rectification circuit 329.

FIGS. 17(a) and 17(b) are diagrams illustrating an insulated transmission medium including two conductor layers and three dielectric material layers. FIG. 17(a) is a diagram illustrating a conductor layer of a first layer and illustrates a substrate external shape 210a, a winding conductor pattern 213 formed in a conductor layer of a first layer, a bridge wiring line 209, and through-vias 208 and 212 to make the conductor layer of the first layer electrically connected to a conductor layer of a second layer. FIG. 17(b) is a diagram illustrating the conductor layer of the second layer and illustrates a substrate external shape 210, a winding conductor pattern 216 formed in the conductor layer of the second layer, a bridge wiring line 217, and the through-vias 208 and 212 to make the conductor layer of the first layer electrically connected to the conductor layer of the second layer. Both the bridge wiring lines 209 and 217 are arranged at the outside of outer circumference of the winding conductor patterns 213 and 216 having a coil shape. The winding conductor pattern 213 formed in the conductor layer of the first layer is electrically connected to the bridge wiring line 217 of the conductor layer of the second layer through the through-via 212. In addition, the winding conductor pattern is electrically connected to an extraction wiring line 211 of the conductor layer of the first layer through the through-via 212. The capacity or the inductance is added to end faces 213a and 213b of the electrically connected conductor in series or in parallel and the conductor resonates. Likewise, the winding conductor pattern 216 formed in the conductor layer of the second layer is electrically connected to the bridge wiring line 209 of the conductor layer of the first layer through the through-via 208. In addition, the winding conductor pattern is electrically connected to an extraction wiring line 215 of the conductor layer of the second layer through the through-via 208. The capacity or the inductance is added to end faces 216a and 216b of the electrically connected conductor in series or in parallel and the conductor resonates.

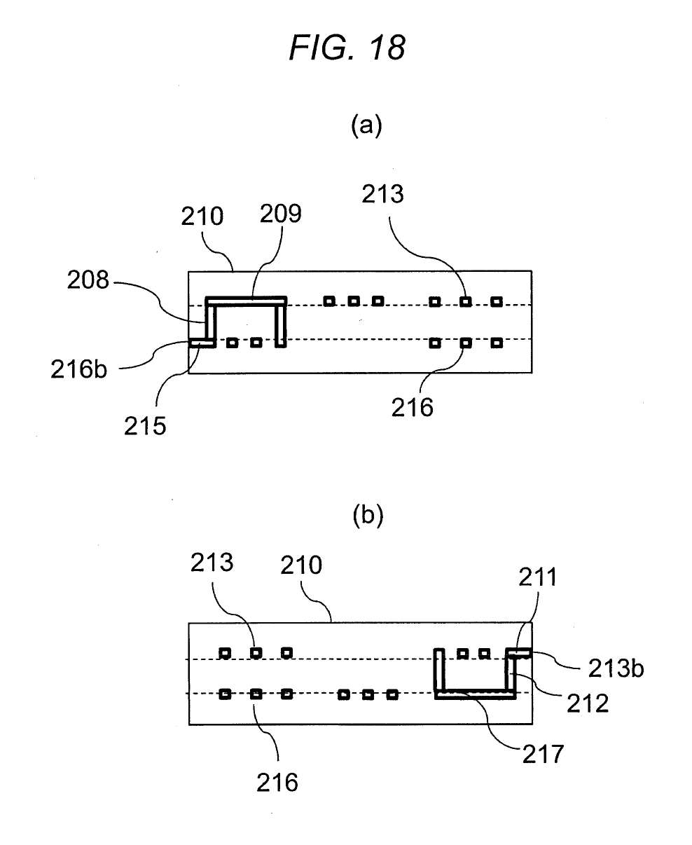

FIGS. 18(a) and 18(b) are cross-sectional views taken along a surface 214a-214b and a surface 214c-214d of FIGS. 17 (a) and 17 (b), respectively. In FIG. 18 (a), the winding conductor pattern 216 formed in the conductor layer of the second layer is electrically connected to the bridge wiring line 209 of the conductor layer of the first layer through the through-via 208. In addition, the winding conductor pattern is electrically connected to the extraction wiring line 215 of the conductor layer of the second layer through the through-via 208. At this time, an exposure surface of the extraction wiring line 215 becomes the end face 216b. The capacity or the inductance is added to the pair of end faces 216a and 216b in series or in parallel. Likewise, in FIG. 18(b), the winding conductor pattern 213 formed in the conductor layer of the first layer is electrically connected to the bridge wiring line 217 of the conductor layer of the second layer through the through-via 212. In addition, the winding conductor pattern is electrically connected to the extraction wiring line 211 of the conductor layer of the first layer through the through-via 212. At this time, an exposure surface of the extraction wiring line 211 becomes the end face 213b. The capacity or the inductance is added to the pair of end faces 213a and 213b in series or in parallel. In the insulated transmission medium of FIGS. 18(a) and 18(b), all of the winding conductors, the bridges, and the through-vias are embedded in an insulator substrate and insulating resistance is improved as compared with the shape in which the metal conductors are exposed to air contact surfaces of the first layer and the third layer of the dielectric material.

FIG. 19 is a diagram illustrating a bridge wiring line position. A bridge wiring line 219 is formed at the outside of outer circumference of the winding conductor pattern 218 to be isolated by a distance u in a horizontal direction and a distance v in a longitudinal direction. At this time, the distances u and v are determined in consideration of insulating resistance at an interface of the first layer and the second layer of the dielectric material layer and an interface of the second layer and the third layer of the dielectric material layer.

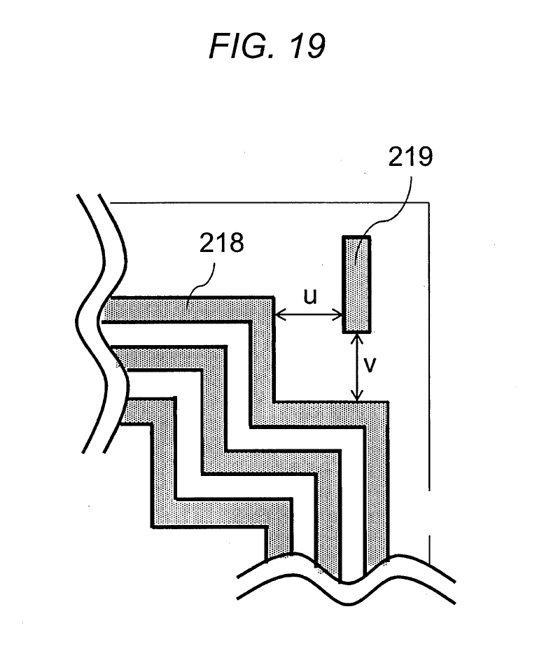

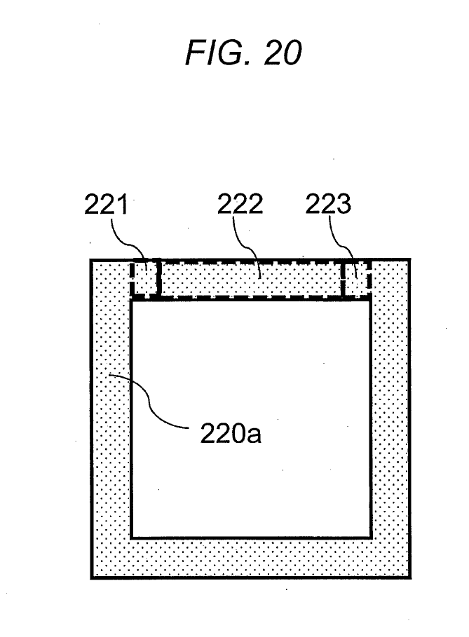

Hereinafter, a method of arranging a bridge wiring line in which an overlapping area of opening surfaces of innermost circumference of conductor patterns of the first layer and the second layer when viewed from a vertical direction is increased and coupling efficiency can be improved will be described using FIGS. 20 to 23. Here, for the simplification of description, shapes of the winding conductor patterns are configured as rectangular shapes and are point-symmetric at the conductor of the first layer and the conductor of the second layer. However, all shapes such as a round shape, an elliptical shape, a polygonal shape, and spirally applicable shapes are included in the present invention.

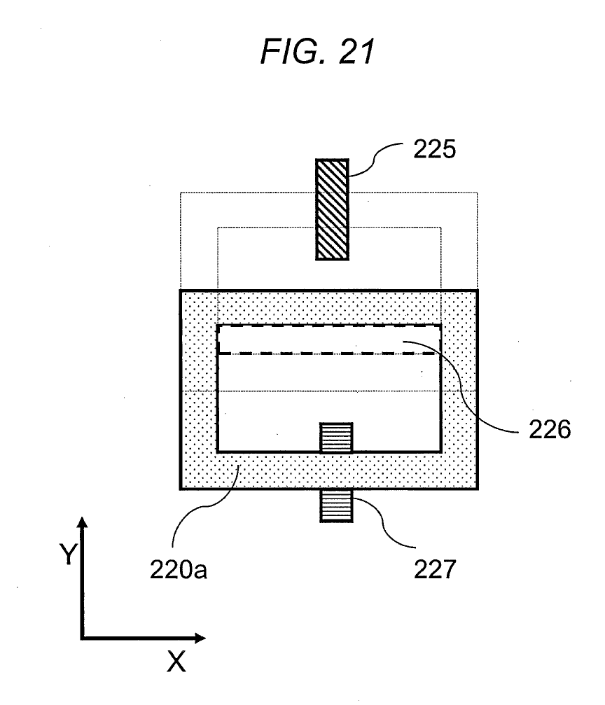

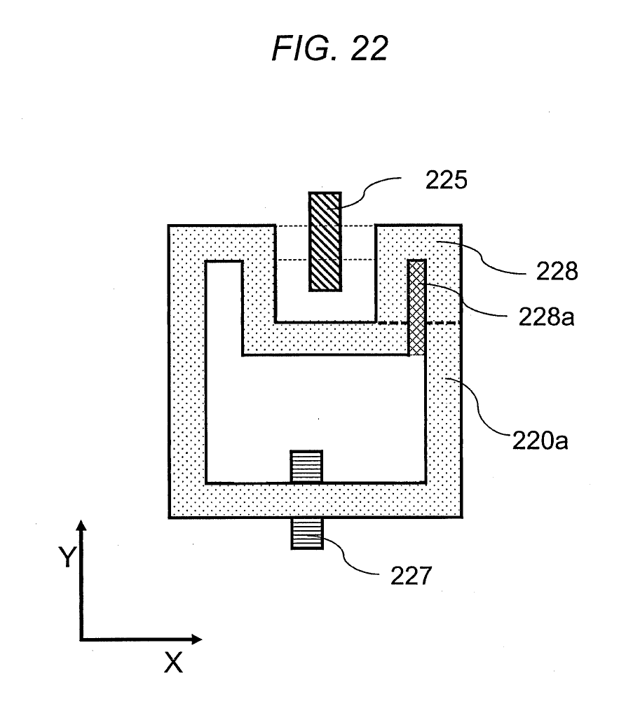

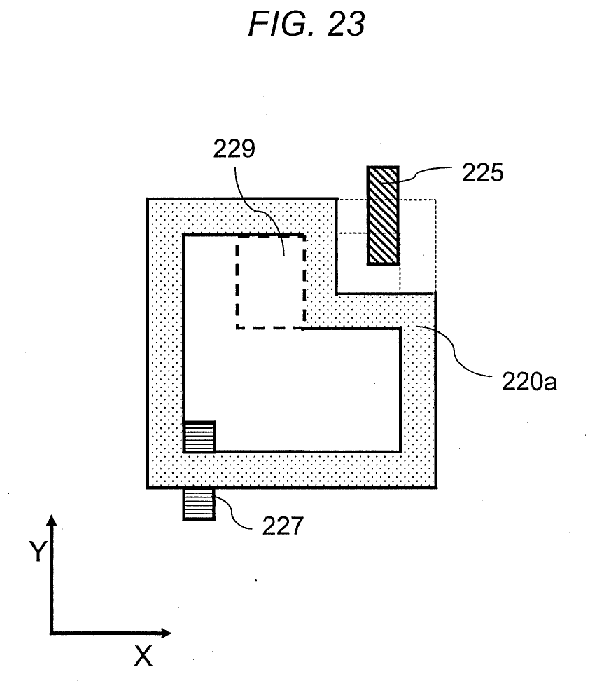

FIG. 20 is a diagram illustrating a shape of an opening surface of a winding conductor pattern. This figure illustrates a winding conductor pattern outline 220a obtained by representing a winding conductor pattern wound at least once in the conductor layer of the first layer by only contour shapes of inner circumference and outer circumference and regions 221, 222, and 223 showing candidate positions of the bridge wiring line. A shape in which the bridge wiring line position is set to an inner portion of the region 222 is illustrated in FIGS. 21 and 22. In addition, a shape in which the bridge wiring line position is set to the region 223 of the corner of the rectangular shape of the conductor pattern is illustrated in FIG. 23. The same discussion as the region 223 can be applied to a shape in which the bridge wiring line position is set to an inner portion of the region 221 and the shapes are line-symmetric at a Y axis, as compared with FIG. 23.

In FIG. 21, the bridge wiring line 225 and the bridge wiring line 227 of the conductor layer facing the bridge wiring line 225 are arranged to be point-symmetric. In the winding conductor pattern outline 220a, a shape is maintained as a rectangular shape and only a length of the Y direction is changed, as compared with FIG. 20. Here, an overlapping portion of opening surfaces of innermost circumference of the conductor patterns of the first layer and the second layer when viewed from a vertical direction is set as a region 226. In this shape, the extension room for the opening area is still left and the coupling efficiency can be improved.

In FIG. 22, the bridge wiring line 225 and the bridge wiring line 227 of the conductor layer facing the bridge wiring line 225 are arranged to be point-symmetric. A removable portion of the winding conductor pattern outline 220a is set as a region 228. Because the winding conductor pattern outline 220a is formed to have the same distance from the bridge wiring line 225, the opening surface of the innermost circumference of the pattern is extended in the Y direction, as compared with FIG. 21. The region 228 of the conductor pattern is bent and formed to sandwich a region 228a. If the position of the bridge wiring line 225 comes close to the region 223, the region 228a becomes small, a gap is removed before long, and a pattern of the region 228 does not contribute to enlarging an opening surface. At this time, the pattern can be short-circuited by removing the region 228.

In FIG. 23, the bridge wiring line 225 and the bridge wiring line 227 of the layer facing the bridge wiring line 225 are arranged to be point-symmetric. A shape of FIG. 23 is the same as a shape in which the bridge wiring line 225 is arranged in the region 223, the conductor pattern region 228 is removed, and the pattern is short-circuited in FIG. 22. A region 229 shows an increase amount of an opening area of the winding conductor pattern outline 220a as compared with the opening area in FIG. 22 and an area thereof becomes equal to an area of the region 228. For this reason, in the embodiment of FIG. 23, the opening area is increased by the region 229 and efficiency is improved, as compared with FIG. 22.

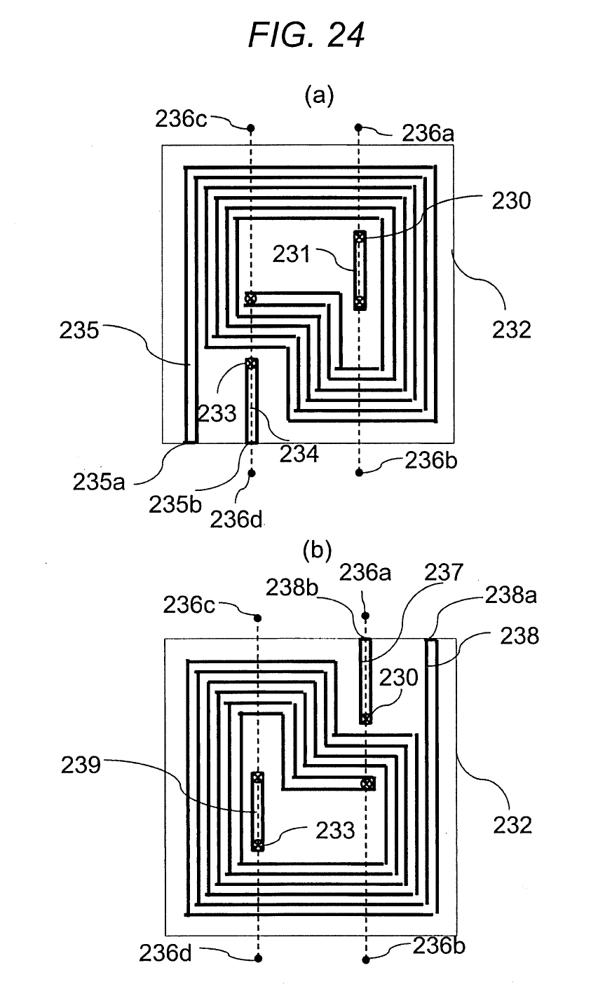

FIGS. 24(a) and 24(b) are diagrams illustrating a modification example of the insulated transmission medium according to the fifth embodiment. FIG. 24(a) is a diagram illustrating the conductor layer of the first layer and illustrates a substrate external shape 232, a winding conductor pattern 235, a bridge wiring line 231, a through-via 230 connected thereto and making conductor layers of a first layer and a second layer electrically connected to each other, an extraction wiring line 234, and a through-via 233 connected thereto and making the conductor layers of the first layer and the second layer electrically connected to each other. The winding conductor pattern 235 formed in the conductor layer of the first layer is electrically connected to a bridge wiring line 239 of the conductor layer of the second layer through the through-via 233. In addition, the winding conductor pattern is electrically connected to the extraction wiring line 234 of the conductor layer of the first layer through the through-via 233. The capacity or the inductance is added to end faces 235a and 235b of the electrically connected conductor in series or in parallel and the conductor resonates. FIG. 24(b) is a diagram illustrating the conductor layer of the second layer and illustrates the substrate external shape 232, the winding conductor pattern 238, the bridge wiring line 239, the through-via 233 connected thereto and making the conductor layers of the first layer and the second layer electrically connected to each other, an extraction wiring line 237, and a through-via 230 connected thereto and making the conductor layers of the first layer and the second layer electrically connected to each other. The winding conductor pattern 238 formed in the conductor layer of the second layer is electrically connected to the bridge wiring line 231 of the conductor layer of the first layer through the through-via 230. In addition, the winding conductor pattern is electrically connected to the extraction wiring line 237 of the conductor layer of the second layer through the through-via 230. The capacity or the inductance is added to end faces 238a and 238b of the electrically connected conductor in series or in parallel and the conductor resonates.

The bridge wiring lines 231 and 239 are arranged at the inner sides of the inner circumference of the winding conductor patterns 235 and 238, respectively. However, the bridge wiring lines are provided at sufficient distances to secure insulating resistance between the inner circumference and the bridge wiring lines. As another modification example, the conductor patterns of the first layer and the second layer can be applied to different shapes, shapes having different sizes, shapes in which one side rotates around the other side, line-symmetric shapes, or shapes in which both sides rotate line-symmetrically.

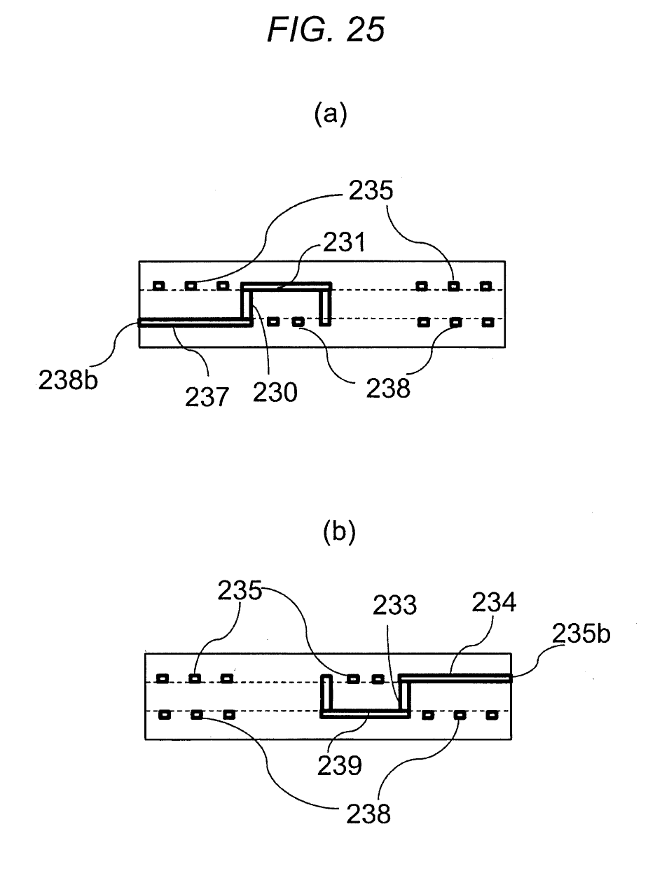

FIGS. 25A and 25B are cross-sectional views taken along a surface 236a-236b and a surface 236c-236d of FIGS. 24(a) and 24(b), respectively. In FIG. 25A, the winding conductor pattern 238 formed in the conductor layer of the second layer is electrically connected to the bridge wiring line 231 of the conductor layer of the first layer through the through-via 230. In addition, the winding conductor pattern is electrically connected to the extraction wiring line 237 of the conductor layer of the second layer through the through-via 230. At this time, an exposure surface of the extraction wiring line 237 becomes the end face 238b. The capacity or the inductance is added to the pair of end faces 238a and 238b in series or in parallel. Likewise, in FIG. 25B, the winding conductor pattern 235 formed in the conductor layer of the first layer is electrically connected to the bridge wiring line 239 of the conductor layer of the second layer through the through-via 233. In addition, the winding conductor pattern is electrically connected to the extraction wiring line 234 of the conductor layer of the first layer through the through-via 233. At this time, an exposure surface of the extraction wiring line 234 becomes the end face 235b. The capacity or the inductance is added to the pair of end faces 235a and 235b in series or in parallel. In the insulated transmission medium of FIGS. 25 (a) and 25 (b), all of the winding conductors, the bridges, and the through-vias are embedded in an insulator substrate and insulating resistance is improved as compared with the shape in which the metal conductors are exposed to air contact surfaces of the first layer and the third layer of the dielectric material.

As described above, the insulated transmission medium according to this embodiment has the dielectric material multilayer substrate that includes the plurality of dielectric material layers, the first resonator that is provided on the substrate and has the first reference potential, and the second resonator that is provided on the substrate, has the second reference potential different from the first reference potential, and is electrically insulated from the first resonator and the electromagnetic energy is transmitted between the first resonator and the second resonator. In particular, the first resonator is a coil-shaped conductor pattern provided on the first layer of the multilayer substrate, the second resonator is a coil-shaped conductor pattern provided on the second layer different from the first layer of the multilayer substrate, a first bridge wiring line to connect a start end and an end point of the conductor pattern of the first resonator is provided on the second layer, and a second bridge wiring line to connect a start point and an endpoint of the conductor pattern of the second resonator is provided on the first layer.

In the insulated transmission medium according to the fifth embodiment, the resonator of the structure of the conductors of the two layers formed of the conductor patterns is embedded in the insulator substrate and insulating resistance is improved as compared with the shape in which the resonator is exposed to air contact surfaces of the first layer and the third layer of the dielectric material. In addition, the area of the opening portion of the innermost circumference of the winding conductor pattern is increased in a limited space, the overlapping area of the opening surfaces of the conductor of the first layer and the conductor of the second layer when viewed from a vertical direction is also increased, coupling efficiency is increased, and a small size and high efficiency can be realized.

### Sixth Embodiment

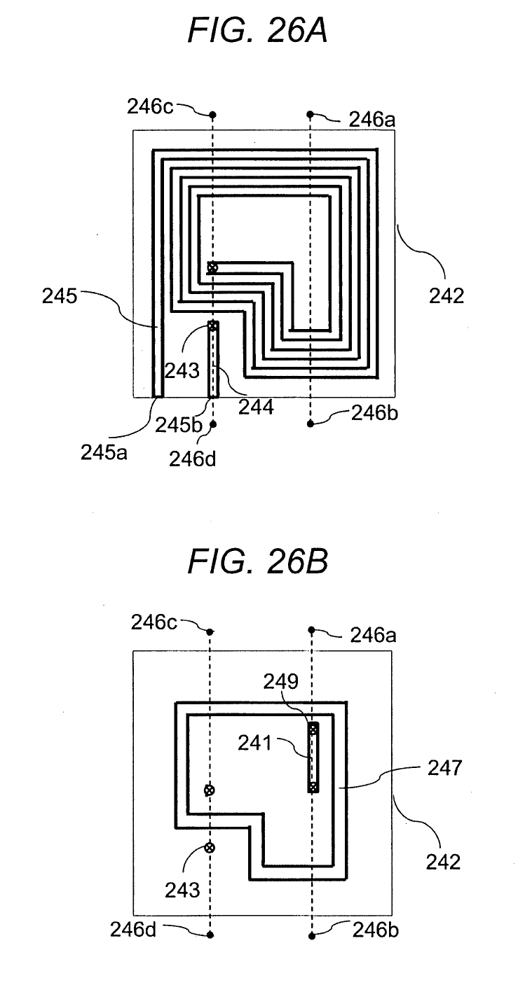

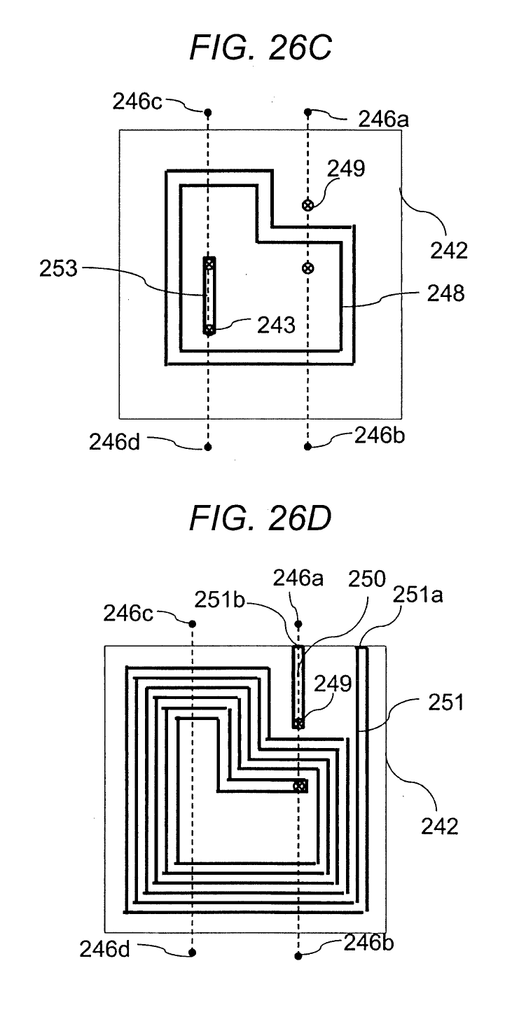

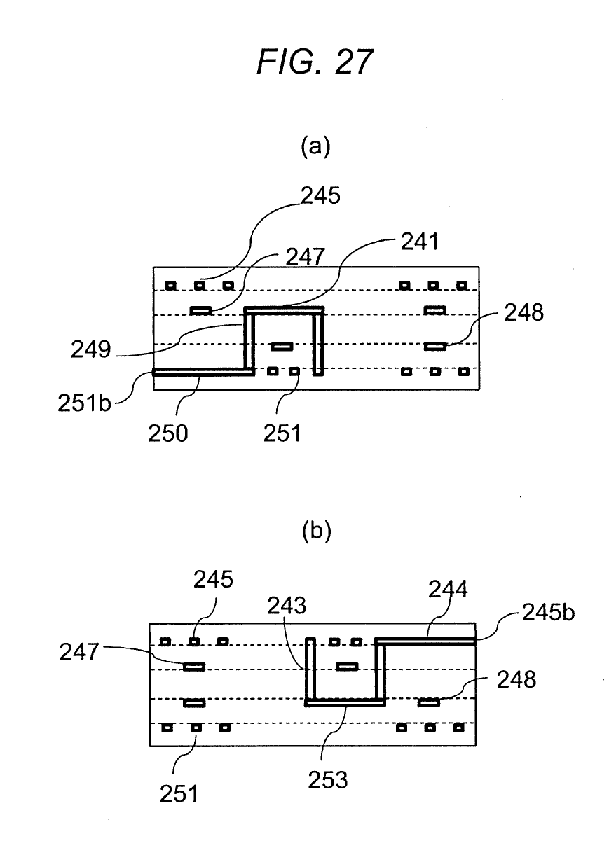

Hereinafter, an insulated transmission medium according to a sixth embodiment of the present invention configured by four conductor layers and five dielectric material layers will be described using FIGS. 26A to 27(b).

FIGS. 26A to 26D are diagrams illustrating the insulated transmission medium according to the sixth embodiment. FIG. 26A is a diagram illustrating a conductor layer of a first layer. A winding conductor pattern 245 formed in a conductor layer of a first layer of an inner side of a substrate external shape 242 is electrically connected to a bridge wiring line 253 of a conductor layer of a third layer through a through-via 243. In addition, the winding conductor pattern is electrically connected to an extraction wiring line 244 of the conductor layer of the first layer through the through-via 243. The capacity or the inductance is added to end faces 245a and 245b of the electrically connected conductor in series or in parallel and the conductor resonates. FIG. 26B is a diagram illustrating a conductor layer of a second layer. The substrate external shape 242, a non-feeding conductor pattern 247 not electrically connected to the other conductors, the through-via 243 electrically connecting the conductor layers of the first, second, and third layers to each other, a bridge wiring line 241, and a through-via 249 connected thereto and electrically connecting the conductor layers of the second and third layers to each other are illustrated. Generally, power transmission efficiency is represented by a function of a magnetic field coupling coefficient k determined depending on an opening area of a winding and a Q coefficient determined depending on impedance of the winding. In addition, the power transmission efficiency increases as the product of the magnetic field coupling coefficient k and the Q coefficient increases. Because the non-feeding conductor pattern 247 does not pass through a circuit to increase a resistance value, the Q coefficient increases as the resistance value decreases. Thereby, the power transmission efficiency increases. FIG. 26C is a diagram illustrating the conductor layer of the third layer. The substrate external shape 242, a non-feeding conductor pattern 248 not electrically connected to the other conductors, the through-via 243 electrically connecting the conductor layers of the first, second, and third layers to each other, a bridge wiring line 253 connected thereto, and the through-via 249 electrically connecting the conductor layers of the second, third, and fourth layers to each other are illustrated. Similar to the non-feeding conductor pattern 247, because the non-feeding conductor pattern 248 does not pass through a circuit to increase a resistance value, the Q coefficient increases as the resistance value decreases. Thereby, the power transmission efficiency increases. The non-feeding conductor patterns 247 and 248 have shapes wound once. However, as another modification example, the non-feeding conductor patterns can be applied to shapes wound two times or more. FIG. 26D is a diagram illustrating the conductor layer of the fourth layer. A winding conductor pattern 251 formed in the conductor layer of the fourth layer of the inner side of the substrate external shape 242 is electrically connected to the bridge wiring line 241 of the conductor layer of the second layer through the through-via 249. In addition, the winding conductor pattern is electrically connected to an extraction wiring line 250 of the conductor layer of the fourth layer through the through-via 249. The capacity or the inductance is added to end faces 251a and 251b of the electrically connected conductor in series or in parallel and the conductor resonates.

FIGS. 27(a) and 27(b) are cross-sectional views taken along a surface 246a-246b and a surface 246c-246d of FIGS. 26A to 26D, respectively. In FIG. 27(a), the winding conductor pattern 251 formed in the conductor layer of the fourth layer is electrically connected to the bridge wiring line 241 of the conductor layer of the second layer through the through-via 249. In addition, the winding conductor pattern is electrically connected to the extraction wiring line 250 of the conductor layer of the fourth layer through the through-via 249. At this time, an exposure surface of the extraction wiring line 250 becomes the end face 251b. The capacity or the inductance is added to the pair of end faces 251a and 251b in series or in parallel. Likewise, in FIG. 27(b), the winding conductor pattern 245 formed in the conductor layer of the first layer is electrically connected to the bridge wiring line 253 of the conductor layer of the third layer through the through-via 243. In addition, the winding conductor pattern is electrically connected to the extraction wiring line 244 of the conductor layer of the first layer through the through-via 243. At this time, an exposure surface of the extraction wiring line 244 becomes the end face 245b. The capacity or the inductance is added to the pair of end faces 245a and 245b in series or in parallel. In the insulated transmission medium of FIGS. 27(a) and 27(b), all of the winding conductors, the bridges, the through-vias, and the non-feeding conductor patterns are embedded in an insulator substrate and insulating resistance is improved as compared with the shape in which the metal conductors are exposed to air contact surfaces of the first layer and the fifth layer of the dielectric material. As another modification example, the insulated transmission medium can be applied to a shape in which the through-via 249 is formed to be electrically connected from the conductor layer of the fourth layer to the conductor layer of the first layer and the bridge wiring line 241 is formed in the conductor layer of the first layer to be connected thereto or a shape in which the through-via 243 is formed to be electrically connected from the conductor layer of the first layer to the conductor layer of the fourth layer and the bridge wiring line 253 is formed in the conductor layer of the fourth layer to be connected thereto.

As described above, in the insulated transmission medium according to the sixth embodiment, the resonator of the structure of the conductors of the two layers formed of the conductor patterns and the non-feeding conductor pattern are embedded in an insulator substrate and insulating resistance is improved as compared with the shape in which the resonator and the non-feeding conductor pattern are exposed to air contact surfaces of the first layer and the fifth layer of the dielectric material. In addition, the area of the opening portion of the innermost circumference of the winding conductor pattern is increased in a limited space, the overlapping area of the opening surfaces of the conductor of the first layer and the conductor of the fourth layer when viewed from a vertical direction is also increased, coupling efficiency is increased, and a small size and high efficiency can be realized. In addition, the non-feeding conductor pattern is arranged in the inner layer of the insulator substrate, so that the Q coefficient is increased and high efficiency is realized.

### Seventh Embodiment

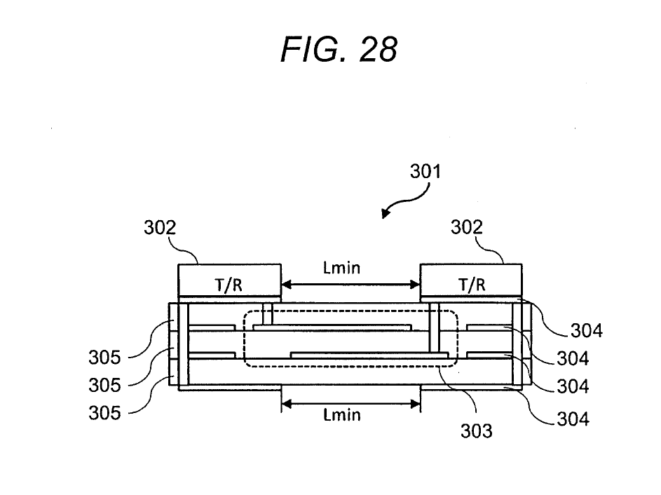

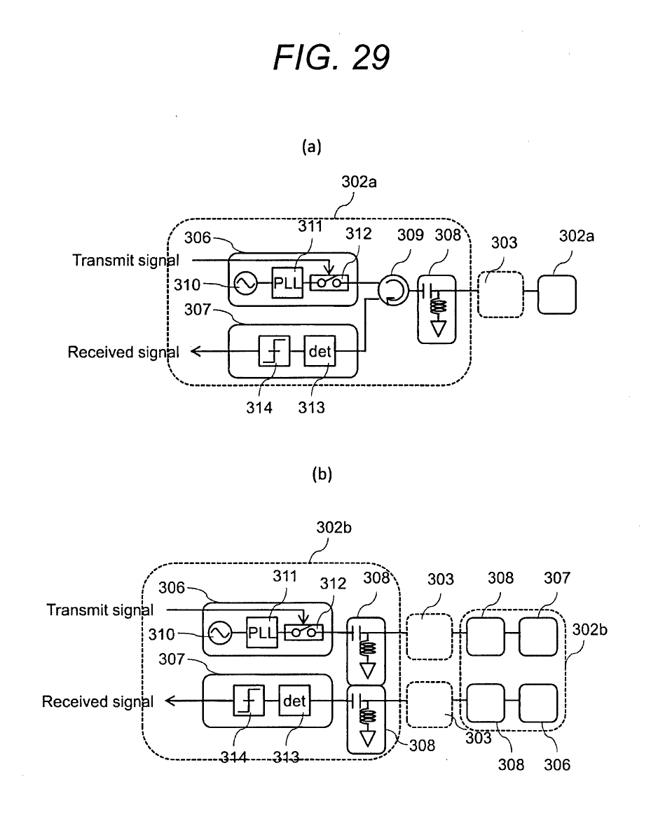

In a seventh embodiment, an example of an insulated transmission apparatus to which the insulated transmission medium described in the previous embodiments is applied will be described with reference to FIGS. 28 to 29(b).

FIG. 28 illustrates a configuration example of an insulated transmission apparatus in which resonators and insulated transmission circuits are configured in a dielectric material multilayer substrate. An insulated transmission apparatus 301 includes insulated transmission circuits 302 isolated by a predetermined distance Lmin or more for insulation and a resonator group 303 configured in a multilayer substrate in which conductors 304 are formed between dielectric material layers 305 and on surfaces of the dielectric material layers. The insulated transmission circuit 302 transmits electromagnetic energy through the resonator group 303. The insulated transmission circuit 302 is, for example, a communication circuit, a feeding circuit, and a power reception circuit and is a circuit to transmit a driving waveform from a logic control unit to a gate driver circuit, transmit a state signal from the gate driver circuit to the logic control unit, or transmit power to the gate driver circuit.

In addition, in FIG. 28, the dielectric material layers 305 are three layers. However, because the resonator group 303 may be formed between the dielectric material layers, the dielectric material layers may be two layers or more.

FIGS. 29 (a) and 29 (b) illustrate a configuration example in which a communication circuit using amplitude modulation is applied to the insulated transmission circuit 302. FIG. 29(a) illustrates a configuration in which the insulated transmission circuit 302 uses one resonator group 303 for transmission and reception and FIG. 29(b) illustrates a configuration in which the insulated transmission circuit 302 uses one resonator group 303 for each of the transmission and reception.

An insulated transmission circuit 302a illustrated in FIG. 29(a) includes a transmitter 306, a receiver 307, a noise removing filter 308, and a circulator 309. When a gate driver to drive an IGBT handles a high voltage in particular, switching noise of a high potential difference is generated through the resonator group 303. The insulated transmission circuit includes the noise removing filter 308 to remove the noise. The circulator 309 outputs an output signal of the transmitter 306 to the resonator group 303 through the noise removing filter 308 and inputs a reception signal received by the resonator group 303 to the receiver 307 through the noise removing filter 308. Meanwhile, the circulator has a function of suppressing signal strength of the output signal of the transmitter 306 input to the receiver 307 low.

The transmitter 306 includes an oscillator 310, a phase-locked loop 311, and a switch 312. The phase-locked loop 311 generates a high frequency signal having a multiplication frequency of a reference signal, on the basis of the reference signal output by the oscillator 310. The high frequency signal is transmitted to the circulator 309 through the switch 312 and a short circuit and opening of the switch 312 are controlled by a transmission signal. Thereby, the transmission signal is transmitted to other insulated transmission circuit 302a through the resonator group 303. For example, the case in which the switch 312 is short-circuited when the transmission signal is a digital signal and the transmission signal has logic 1 and the switch 312 is opened when the transmission signal has logic 0 will be described. In this case, when the logic 1 is transmitted, the high frequency signal is output from the transmitter 306 and the high frequency signal is received in other insulated transmission circuit 302a through the resonator group 303. Meanwhile, when the logic 0 is transmitted, the high frequency signal is not output from the transmitter 306 and other insulated transmission circuit 302a does not receive the high frequency signal. In this way, the signal can be transmitted.

The receiver 307 includes a detector 313 and a comparator 314. The detector 313 detects an amount of power of a predetermined high frequency signal included in the reception signal. The comparator 314 determines whether the power of the high frequency signal detected by the detector 313 is more than a predetermined threshold value. By appropriately setting the threshold value, power of noise or an interfering wave and signal power received from other insulated transmission circuit 302a can be distinguished from each other and a signal can be securely received.

An insulated transmission circuit 302b illustrated in FIG. 29(b) includes a transmitter 306, a receiver 307, and noise removing filters 308 and an output of the transmitter 306 and an input of the receiver 307 are connected to different resonator groups 303 through the different noise removing filters 308, respectively. By this configuration, the circulator 309 becomes unnecessary. When the two insulated transmission circuits 302b are connected through the resonator groups 303, the receiver 307 of the other insulated transmission circuit 302b is connected to the resonator group 303 to which the transmitter 306 of one insulated transmission circuit 302b is connected. In this way, bidirectional communication is enabled by using the two resonator groups 303.

The example of the case in which the high frequency signal is generated by the phase-locked loop 311 has been described. However, the present invention is not limited to the phase-locked loop and a frequency-locked loop or a voltage-controlled oscillator may be used. In addition, because the switch 312 or the circulator 309 is exemplified to describe a function thereof, the switch or the circulator may be configured by another mechanism in an actual circuit. For example, instead of the switch 312, a multiplier may be used and instead of the circulator 309, a directional coupler may be used. In addition, when the transmission and the reception are not performed at the same time, the transmission and the reception may be switched using the switch, instead of the circulator 309, and an operation may be executed.

In addition, the transmitter and the receiver have been exemplified. However, one insulated transmission circuit may include only the transmitter and the other insulated transmission circuit may include only the receiver.

In addition, a modulation method is not limited to the amplitude modulation and frequency modulation or other modulation method may be used and power may be transmitted without the modulation.

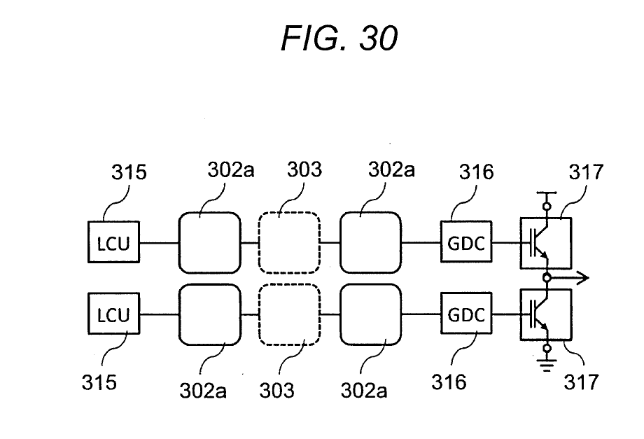

FIG. 30 illustrates an example of the case in which the configuration of FIG. 29(a) is applied to an inverter. The inverter is configured by two switching elements 317 such as an IGBT and a gate driving signal of an IGBT element is generated by the gate driver circuit 316. A driving signal applied to the gate driver circuit 316 is generated by the logic control unit 315. The insulated transmission circuit 302a and the resonator group 303 are used for transmitting the driving signal between the logic control unit 315 and the gate driver circuit 316. At this time, because bidirectional communication is enabled in the insulated transmission circuit 302a, transmission of the driving signal to the gate driver 316 and transmission of a state signal showing a state of the gate driver from the gate driver 316 to the logic control unit 315 may be performed at the same time.

If the three same configurations are arranged, three inverters can be driven. Thereby, a three-phase motor can be driven. In addition, if the three or more configurations are prepared, an application to a cascade inverter in which multiple small inverters are connected in series is also enabled.

The description has been given using the configuration of FIG. 29(a). However, it is obvious that the same effects are obtained even though the configuration of FIG. 29 (b) is used.

The insulated transmission apparatus according to the seventh embodiment has the dielectric material multilayer substrate that includes the plurality of dielectric material layers, the first resonator that is provided on the substrate and has the first reference potential, and the second resonator that is provided on the substrate, has the second reference potential different from the first reference potential, and is electrically insulated from the first resonator. The first resonator has the first circuit that includes the first main resonating unit and the first auxiliary resonating unit and is electrically connected to the insulated transmission medium and the first resonator of the insulated transmission medium and the second circuit that is electrically connected to the second resonator of the insulated transmission medium. The electromagnetic energy is transmitted between the first circuit and the second circuit through the insulated transmission medium.

If the configuration of the insulated transmission apparatus according to this embodiment is applied, the electromagnetic energy can be transmitted between the insulated transmission circuits arranged at the predetermined distance for insulation.

In addition, the inverter or the motor can be driven by using the plurality of insulated transmission apparatuses.

### Eighth Embodiment

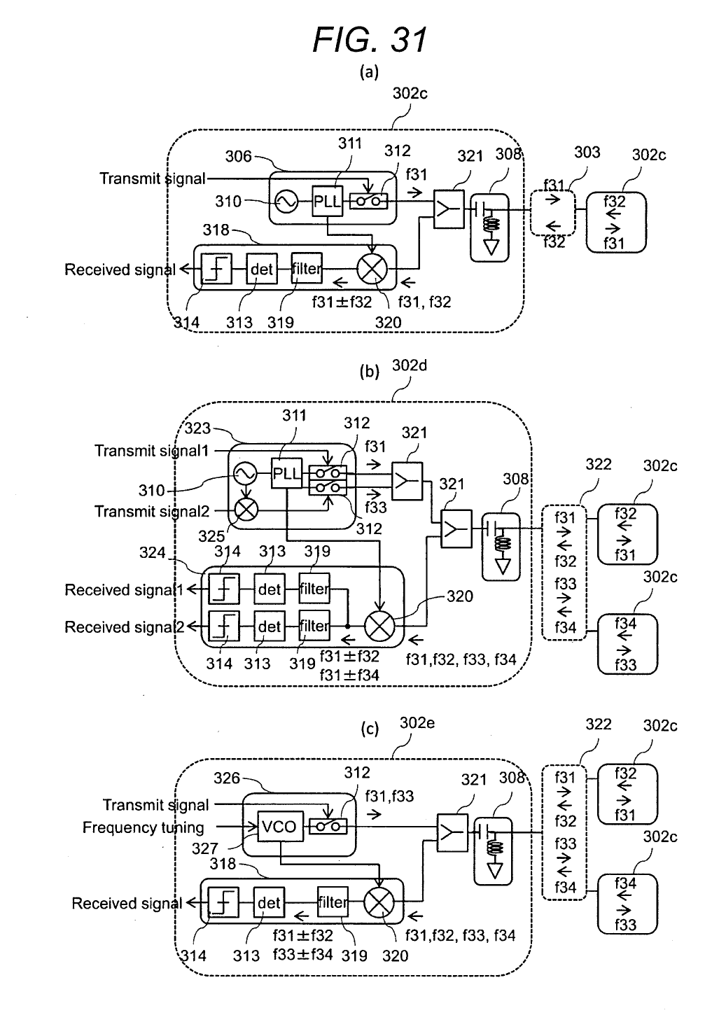

In an eighth embodiment, an example of other insulated transmission apparatus to which the insulated transmission medium described in the previous embodiments is applied will be described with reference to FIGS. 31(a) to 32(b).

FIGS. 31(a) to 31(c) illustrate a configuration example of the case in which a communication circuit where transmission and reception are subjected to frequency division using amplitude modulation is applied to an insulated transmission circuit 302. FIG. 31(a) illustrates a configuration example of the case in which bidirectional communication is performed between two insulated transmission circuits 302 and FIGS. 31(b) and 31(c) illustrate a configuration example of the case in which the bidirectional communication is performed between one insulated transmission circuit 302 and two insulated transmission circuits.

An insulated transmission circuit 302c illustrated in FIG. 31(a) includes a transmitter 306, a receiver 318, a coupler/distributor 321, and a noise removing filter 308. The receiver 318 includes a multiplier 320 to multiply a reception signal and a signal of a phase-locked loop 311, a filter 319 to decrease a frequency component other than the reception signal, a detector 313, and a comparator 314. The coupler/distributor 321 has a function of connecting the transmitter 306, the receiver 318, and the noise removing filter 308, transmitting an output signal of the transmitter 306 to a resonator group 303 through the noise removing filter 308, and transmitting a signal received by the resonator group 303 to the receiver 318 through the noise removing filter 308. Because the transmission and the reception are subjected to the frequency division, as in the circulator 309 illustrated in FIGS. 29 (a) and 29 (b), the function of suppressing the signal strength of the output signal of the transmitter input to the receiver low is unnecessary.

In communication between the two insulated transmission circuits 302c, two frequencies may be used. A frequency of a transmission signal of one insulated transmission circuit 302c is set as f31 and a frequency of a transmission signal of the other insulated transmission circuit 302c is set as f32. In this case, the insulated transmission circuit 302c of which the frequency of the transmission signal is f31 may receive a signal of f32. An operation of the receiver 318 in the case of receiving f32 will be described.

The two signals of the transmission signal f31 of the self-circuit and the transmission signal (desired reception signal) f32 of the other circuit are input to the multiplier 320. If the two signals and the output signal of the phase-locked loop 311 of the self-circuit are multiplied, the output signal of the multiplier 320 becomes a direct-current signal and a signal of f31±f32. The direct-current signal is a result obtained by multiplying the signals of f31. Because a frequency of the desired reception signal is f32, the signal of f31±f32 becomes a frequency of the desired reception signal in an output of the multiplier 320. Therefore, a filter 319 to remove a direct-current component and pass a component of f31±f32 is used, so that the desired reception signal f32 can be transmitted to the detector 313.

For the frequency such as f31 or f32, f31 and f32 may be set to 2400 MHz and 2480 MHz, respectively, using a 2.4 GHz band to be an ISM band. In this case, f31±f32 becomes 80 MHz and the filter 319 to separate the direct current and 80 MHz is prepared.

In addition, the resonator group 303 does not need to have a characteristic to pass the two frequencies of f31 and f32. The resonator group 303 may be made to have the two resonance frequencies or have a wide band characteristic. For example, if f31 is 2400 MHz and f32 is 2480 MHz, a frequency difference between f31 and f32 is small. Therefore, the resonator group is preferably configured to have the wide band characteristic and pass both f31 and f32 at a low loss.

An insulated transmission circuit 302d illustrated in FIG. 31(b) includes a transmitter 323 to transmit two signals of frequencies f31 and f33, a receiver 324 to receive two signals of frequencies f32 and f34, a coupler/distributor 321, and a noise removing filter 308. The resonator group 322 has a wide band characteristic or has a plurality of resonance frequencies, such that the four signals of the frequencies f31, f32, f33, and f34 can be transmitted.

The transmitter 323 outputs two high frequency signals. One signal is a transmission signal 1 and a signal output by controlling the switch 312 and the other signal is a signal obtained by multiplying a transmission signal 2 and a reference signal of the oscillator 310 by the multiplier 325 and a signal output by controlling the switch 312. For example, if a frequency of the reference signal of the oscillator 310 is set to 20 MHz and a frequency of an output signal of the phase-locked loop 311 is set to 2420 MHz, f31 becomes 2420 MHz and f33 becomes 2400 MHz and 2440 MHz. Meanwhile, the frequency f32 of the output signal of the opposite insulated transmission circuit 302c is set to 2415 MHz and the frequency f34 is set to 2445 MHz. The frequency of the output signal of the multiplier 320 becomes 5 MHz when f32 is received and becomes 45 MHz when f34 is received. Meanwhile, the signals f31 and f33 of the self-circuit become the direct current and 20 MHz, respectively. Therefore, as the filter 319, a low-pass filter may be prepared when f32 and f33 are separated and a high-pass filter may be prepared when f34 and f33 are separated.

In addition, f33 becomes two frequencies of 2400 MHz and 2440 MHz. However, 2400 MHz may be removed by inserting a filter into an output terminal of the transmitter 323. In this way, spread of the extra frequency band can be prevented.

The example of the case in which the high frequency signal is generated by the phase-locked loop 311 has been described. However, the present invention is not limited to the phase-locked loop and a frequency-locked loop or a voltage-controlled oscillator may be used. In addition, when the transmission and the reception are not performed at the same time, instead of the coupler/distributor, a switch may be used. Likewise, various mounting mechanisms exist for the other components.

In addition, the resonator group 322 needs to have a characteristic to pass the four frequencies of f31, f32, f33, and f34. An element connected to the insulated transmission circuit 302d in two elements configuring the resonator group 322 is preferably made to have a plurality of resonance frequencies or have a wide band characteristic to correspond to all of the four frequencies. Meanwhile, an element connected to the insulated transmission circuit 302c may correspond to any two frequencies. The element connected to the insulated transmission circuit 302d does not need to have a wide band characteristic and the resonator is resonated in only a frequency band used by the connected insulated transmission circuit 302c, so that an influence on communication of the other insulated transmission circuit 302c can be alleviated.

Because communication with the two insulated transmission circuits 302c is enabled by one insulated transmission circuit 302d, the inverter can be driven. If the three same configurations are prepared or a frequency division number is increased three times, three inverters can be driven. Thereby, a three-phase motor can be driven. If the three or more configurations are prepared, an application to a cascade inverter in which multiple small inverters are connected in series is also enabled. By preparing the two configurations of FIG. 31(a), the inverter can be driven, similar to FIG. 31 (b).

In addition, the modulation method is not limited to the amplitude modulation and frequency modulation or other modulation method may be used.

An insulated transmission circuit 302e illustrated in FIG. 31(c) includes a transmitter 326 to transmit two signals of frequencies f31 and f33, a receiver 318 to receive two signals of frequencies f32 and f34, a coupler/distributor 321, and a noise removing filter 308. The resonator group 322 has a wide band characteristic or has a plurality of resonance frequencies, such that the four signals of the frequencies f31, f32, f33, and f34 can be transmitted.

The transmitter 326 includes a voltage-controlled oscillator 327 and a switch 312 and an oscillation frequency is controlled by a voltage of a frequency adjustment signal in the voltage-controlled oscillator 327. In this way, the oscillation frequency can be changed according to a desired communication partner and communication with a specific partner is enabled. In the receiver 318, because a reception enabled frequency is changed by a signal frequency of the voltage-controlled oscillator 327 input to the multiplier 320, a signal from the specific partner can be received by changing the oscillation frequency of the voltage-controlled oscillator.

In addition, the voltage-controlled oscillator 327 may be realized by any realizing mechanism, as long as an output frequency is variable. For example, a division number of the phase-locked loop may be changed. In addition, the modulation method is not limited to the amplitude modulation and frequency modulation or other modulation method may be used.

FIGS. 32 (a) and 32 (b) illustrate a configuration example of an insulated power transmission apparatus in the case in which power transmission is performed. FIG. 32(a) illustrates a configuration example of the case in which the power transmission is performed and FIG. 32(b) illustrates a configuration example of the case in which the communication and the power transmission are performed at the same time. The insulated power transmission apparatus illustrated in FIG. 32(a) includes an oscillator 310, an amplifier 328, a resonator group 303, a rectification circuit 329, and a regulator 330. Power output by the amplifier 328 is received by the rectification circuit 329 through the resonator group 303 and the regulator 330 adjusts a level to a desired voltage level and outputs the power. For example, an output of the regulator 330 is connected to a power supply of a gate driver circuit driving an IGBT element and is used.

An insulated communication/power transmission apparatus illustrated in FIG. 32(b) is obtained by adding the configuration of the power transmission circuit of FIG. 32(a) to the configuration of the insulated transmission circuit of FIG. 31(a). Both signals are synthesized by the coupler/distributor 321. As described in FIGS. 29(a) and 29(b), the communication and the power transmission can be performed at the same time by performing the frequency division. At this time, the noise removing filter 308 is preferably designed such that impedance does not decrease at a frequency used for the power transmission.

If the configuration of the insulated transmission apparatus according to the eighth embodiment is applied, the electromagnetic energy can be simultaneously transmitted without interference, between the plurality of insulated transmission circuits arranged at the predetermined distance for insulation, in addition to the effects according to the first embodiment.

In addition, the electromagnetic energy can be transmitted between one insulated transmission apparatus and the plurality of insulated transmission apparatuses.

In addition, the inverter or the motor can be driven by using the plurality of insulated transmission apparatuses.

In addition, the different frequencies are used for the communication and the power transmission, so that both the communication and the power transmission can be simultaneously performed using a set of resonators.

### Ninth Embodiment

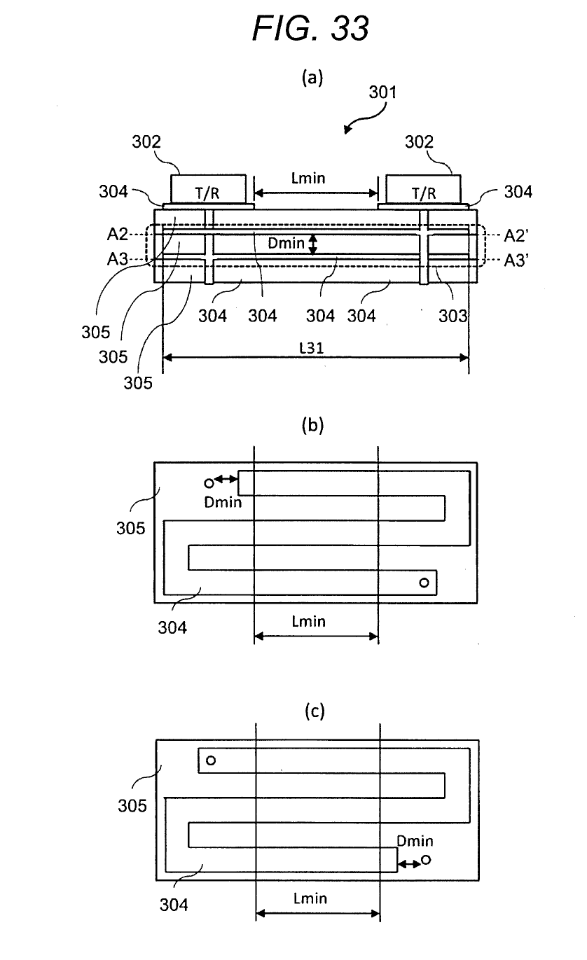

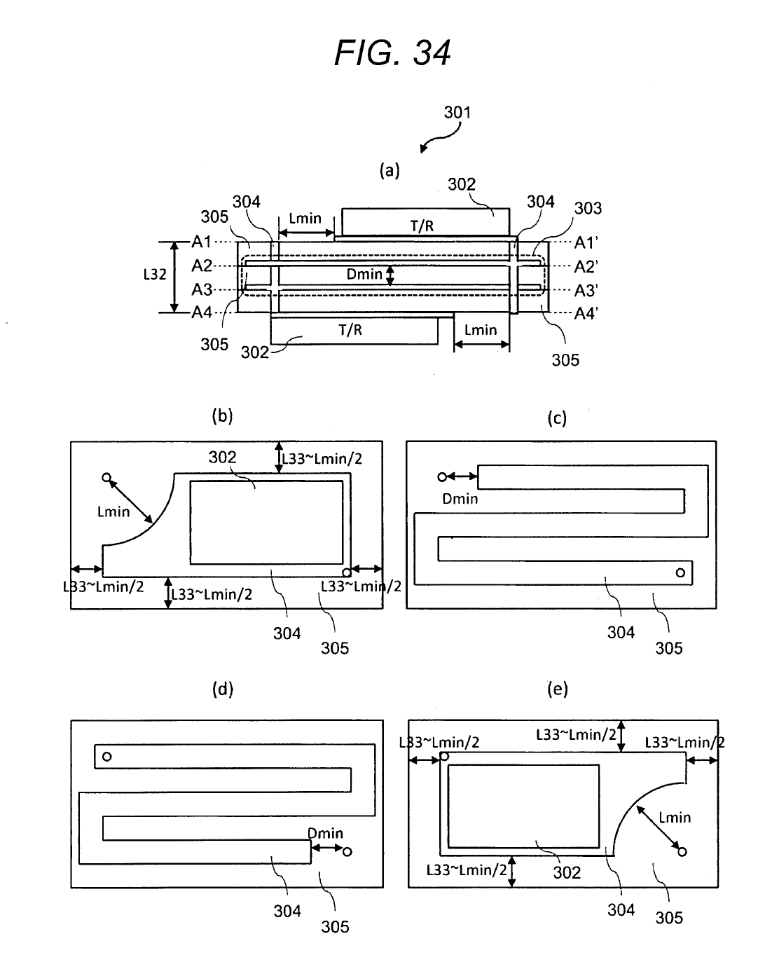

In a ninth embodiment, a configuration example of an insulated transmission apparatus in which the insulated transmission medium and the insulated transmission circuit described in the previous embodiments are mounted to a multilayer substrate will be described with reference to FIGS. 33(a) to 34(e).

FIGS. 33(a) to 33(c) illustrate a configuration example of an insulated transmission apparatus in which resonators and insulated transmission circuits are configured in a dielectric material multilayer substrate. In particular, in this configuration example, the insulated transmission circuits 302 are arranged to be isolated by a predetermined distance Lmin or more to secure insulation. However, at least one side of the resonator group 303 has a size of the distance Lmin or more. FIG. 33(a) is a cross-sectional view, FIG. 33(b) is a diagram illustrating a surface of A2-A2′ when viewed from an upper portion where the insulated transmission circuit 302 is arranged, and FIG. 33(c) is a diagram illustrating a surface of A3-A3′ when viewed from the upper portion where the insulated transmission circuit 302 is arranged.

As illustrated in FIGS. 33(b) and 33(c), the resonator group 303 has a long side L31 of the predetermined distance Lmin or more. In addition, the distance of the conductor 304 connected to one insulated transmission circuit 302 and the conductor 304 connected to the other insulated transmission circuit 302 is equal to or more than the predetermined distance Dmin to secure insulation in the dielectric material.

Because the conductor 304 on the surfaces A2-A2′ and A3-A3′ illustrated in FIGS. 33(b) and 33(c) is smaller than an external shape of the dielectric material layer 305, the conductor is not exposed at the side of the dielectric material multilayer substrate.

As such, the resonator group 303 is formed in the dielectric material multilayer substrate. For this reason, even though a size of the resonator group 303 is large, the distance between the insulated transmission circuits 302 may be the predetermined distance Lmin to secure the insulation and thus, a mounting area can be decreased.

In FIGS. 33(a) to 33(c), the dielectric material layers 305 are the three layers. However, because the resonator group 303 may be formed between the dielectric material layers, the dielectric material layers may be two layers or more.

In addition, the number of insulated transmission circuits 302 and the number of resonator groups 303 are not limited to two and one, respectively, and the same application is enabled to three or more insulated transmission circuits 302 or two or more resonator groups 303.

In addition, the structure of the resonator group 303 illustrated in FIGS. 33(a) to 33(c) is exemplary and the resonators described in the previous embodiments may be used.

The dielectric material layers may be increased, the conductors 304 to which the reference potential is applied may be arranged between the insulated transmission circuit 302 and the resonator group 303, and shielding may be performed such that noise does not propagate between the insulated transmission circuit 302 and the resonator group 303.

FIGS. 34(a) to 34(e) illustrate a configuration example of an insulated transmission apparatus in which resonators and insulated transmission circuits are configured in a dielectric material multilayer substrate. In particular, in this configuration example, one insulated transmission circuit 302 is arranged on a substrate surface of the side opposite to the other insulated transmission circuit 302. FIG. 34(a) is a cross-sectional view and FIGS. 34(b) to 34(e) are diagrams illustrating surfaces A1-A1′, A2-A2′, A3-A3′, and A4-A4′ when viewed from an upper portion of the insulated transmission circuit 302 arranged on the surface A1-A1′.

On the substrate surface, the conductor 304 connected to one insulated transmission circuit 302 and the conductor 304 connected to the other insulated transmission circuit 302 are arranged in places isolated by the predetermined distance Lmin or more to secure insulation. In addition, in the dielectric material, the conductors are arranged in the places isolated by the predetermined distance Dmin or more to secure the insulation in the dielectric material.

In addition, the conductor 304 connected to one insulated transmission circuit 302 arranged on the surfaces A1-A1′ and A4-A4′ and the conductor 304 connected to the other insulated transmission circuit 302 are arranged in the places isolated by the predetermined distance Lmin or more to secure the insulation. For example, when a thickness L32 of the substrate is sufficiently small and can be ignored for the distance Lmin, a distance from a substrate end face to the conductor 304 may be Lmin/2.

As such, the resonator group 303 is formed in the dielectric material multilayer substrate. For this reason, even though a size of the resonator group 303 is large, the distance between the insulated transmission circuits 302 may be the predetermined distance Lmin to secure the insulation and thus, a mounting area can be decreased.

In addition, the mounting area can be decreased by arranging the insulated transmission circuit 302 on both surfaces of the substrate.

In addition, in FIGS. 34(a) to 34(e), the dielectric material layers 305 are the three layers. However, because the resonator group 303 may be formed between the dielectric material layers, the dielectric material layers may be two layers or more.

In addition, the number of insulated transmission circuits 302 and the number of resonator groups 303 are not limited to two and one, respectively, and the same application is enabled to three or more insulated transmission circuits 302 or two or more resonator groups 303. When the three or more insulated transmission circuits 302 exist, the two insulated transmission circuits among the three insulated transmission circuits are arranged on the same surface.

In addition, the structure of the resonator group 303 illustrated in FIGS. 34(a) to 34(e) is exemplary and the resonators described in the previous embodiments may be used.

The dielectric material layers may be increased, the conductors 304 to which the reference potential is applied may be arranged between the insulated transmission circuit 302 and the resonator group 303, and shielding may be performed such that noise does not propagate between the insulated transmission circuit 302 and the resonator group 303.

If the configuration of the insulated transmission apparatus according to the ninth embodiment is applied, the electromagnetic energy can be transmitted between the insulated transmission circuits arranged at the predetermined distance for insulation. In addition, even though the resonator having the size more than the predetermined distance Lmin for insulation is used, a mounting area can be suppressed from increasing. In addition, the mounting area can be further decreased by arranging the insulated transmission apparatuses on a surface and a back surface of the substrate. In addition, the inverter or the motor can be driven by using the plurality of insulated transmission apparatuses.

The present invention is not limited to the embodiments described above and various modification examples are included in the present invention. For example, the embodiments are described in detail to facilitate the description of the present invention and are not limited to embodiments in which all of the described configurations are included. In addition, a part of the configuration example of the certain embodiment can be replaced by another configuration example of the same embodiment or the configuration example of another embodiment and the configuration of another configuration example of the same embodiment or the configuration example of another embodiment can be added to the configuration example of the certain embodiment. In addition, for a part of the configurations of the individual embodiments, other configurations can be added, deleted, and replaced.

### REFERENCE SIGNS LIST

101 dielectric material multilayer substrate
102 logic control unit
103 communication device
104 gate driver circuit
105 switching element
106 external interface main conductor
107 interface main via
108 resonator main conductor
109 interface auxiliary via
110 external interface auxiliary conductor
111 internal interface main conductor
112 internal interface auxiliary conductor
113, 114, 116 capacitance component
115 self-induction component
117 mutual induction component
118 dielectric material layer
119 passage amount
120 reflection amount
121 resonator auxiliary conductor
122, 123, 124 resonator main conductor
125 resonator main via
126, 128 resonator main conductor
129 internal interface auxiliary conductor
132 resonator auxiliary via
133, 136, 137 resonator auxiliary conductor
138 external interface conductor
200 electromagnetic wave transmitting device
210, 232, 242 substrate external shape
208, 212, 230, 233, 243, 249 through-via
209, 217, 219, 225, 227, 231, 239, 241, 253 bridge wiring line
213, 216, 218, 235, 238, 245, 251 winding conductor pattern
213a, 213b, 216a, 216b, 235a, 235b, 238a, 238b, 245a, 245b, 251a,
251b end face
211, 215, 234, 237, 244, 250 extraction wiring line
221, 222, 223 region
220a winding conductor pattern outline
226 region
228 region
228a region
229 region
247, 248 non-feeding conductor pattern
301 insulated transmission apparatus
302 insulated transmission circuit
303, 322 resonator group
304 conductor
305 dielectric material layer
306, 323, 326 transmitter
307, 318, 324 receiver
308 noise removing filter
309 circulator
310 oscillator
311 phase-locked loop
312 switch
313 detector
314 comparator
315 logic control unit
316 gate driver circuit
317 switching element
319 filter
320, 325 multiplier
321 coupler/distributor
327 voltage-controlled oscillator
328 amplifier
329 rectification circuit
330 circulator

1. An insulated transmission medium, comprising:
a dielectric material multilayer substrate which includes a plurality of dielectric material layers;
a first resonator which is provided on the substrate and has a first reference potential; and
a second resonator which is provided on the substrate, has a second reference potential different from the first reference potential, and is electrically insulated from the first resonator,
wherein electromagnetic energy is transmitted between the first resonator and the second resonator.

2. The insulated transmission medium according to claim 1, wherein
the first resonator includes a first main resonating unit and a first auxiliary resonating unit, and
the second resonator includes a second main resonating unit and a second auxiliary resonating unit.

3. The insulated transmission medium according to claim 2, wherein
the first resonator is provided on a first dielectric material layer,
the second resonator is provided on a second dielectric material layer of a layer lower than the first dielectric material layer, and
a third dielectric material layer is provided above the first dielectric material layer.

4. The insulated transmission medium according to claim 2, wherein at least one of the first resonator and the second resonator is provided over the plurality of dielectric material layers.

5. The insulated transmission medium according to claim 2, wherein the number of each of the first and second auxiliary resonating units is plural.

6. The insulated transmission medium according to claim 2, wherein the both of the first resonator and the second resonator are conductors.

7. The insulated transmission medium according to claim 3, wherein the first main resonating unit is bent several times.

8. The insulated transmission medium according to claim 3, further comprising:
a floating resonator which is insulated from the first resonator and the second resonator by the dielectric material layer,
wherein the electromagnetic energy is transmitted between the first resonator and the second resonator through the floating resonator.

9. The insulated transmission medium according to claim 7, wherein the first auxiliary resonating unit is provided at positions sandwiching the first main resonating unit.

10. The insulated transmission medium according to claim 9, wherein the number of each of the first and second resonators is plural.

11. The insulated transmission medium according to claim 1, wherein
the first resonator is a coil-shaped conductor pattern which is provided on a first layer of the multilayer substrate,
the second resonator is a coil-shaped conductor pattern which is provided on a second layer different from the first layer of the multilayer substrate,
a first bridge wiring line to connect a start point and an end point of the conductor pattern of the first resonator is provided on the second layer, and
a second bridge wiring line to connect a start point and an end point of the conductor pattern of the second resonator is provided on the first layer.

12. The insulated transmission medium according to claim 11, wherein
the first resonator and the second resonator are point-symmetric,
outer circumference of the first resonator and the second bridge wiring line are isolated from each other such that both sides are insulated from each other, and
outer circumference of the second resonator and the first bridge wiring line are isolated from each other such that both sides are insulated from each other.

13. An insulated transmission apparatus, comprising:
an insulated transmission medium having a dielectric material multilayer substrate which includes a plurality of dielectric material layers, a first resonator which is provided on the substrate and has a first reference potential, and a second resonator which is provided on the substrate, has a second reference potential different from the first reference potential, and is electrically insulated from the first resonator, the first resonator including a first main resonating unit and a first auxiliary resonating unit;
a first circuit which is electrically connected to the first resonator of the insulated transmission medium; and
a second circuit which is electrically connected to the second resonator of the insulated transmission medium,
wherein electromagnetic energy is transmitted between the first circuit and the second circuit through the insulated transmission medium.

14. The insulated transmission apparatus according to claim 13, wherein a plurality of signals are simultaneously transmitted between the first circuit and the second circuit.

15. The insulated transmission apparatus according to claim 13, wherein communication and power transmission are simultaneously performed between the first circuit and the second circuit.
